(19) United States
(12) Patent Application Publication
(10) Pub. No.: US 2026/0062516 A1
(43) Pub. Date: Mar. 5, 2026

(54) IMIDAZOLE-BASED POLYIMIDE MEMBRANES FOR SOUR NATURAL GAS SEPARATION

(71) Applicant: Saudi Arabian Oil Company, Dhahran (SA)

(72) Inventors: Ali Hayek, Dhahran (SA); Abdulkarim Alsamah, Dhahran (SA); Rashed H. Alhajry, Dammam (SA)

(21) Appl. No.: 18/819,423

(22) Filed: Aug. 29, 2024

(51) Int. Cl. C08G 73/10; B01D 53/22; B01D 71/64; C10L 3/10

(52) U.S. Cl. CPC C08G 73/1085; B01D 53/228; B01D 71/64; C08G 73/1032; C08G 73/1039; C08G 73/1042; C08G 73/1067; C10L 3/103; C10L 3/104; B01D 2256/245; B01D 2257/304; B01D 2257/504

(57) ABSTRACT

Polymeric membranes that incorporate an imidazole moiety that can be used in sour natural gas separation and purification applications.

### TECHNICAL FIELD

This document relates to copolyimides containing imidazole moieties and to membranes containing the copolyimides. This document also relates to methods of using the membranes for sour natural gas purification applications.

### BACKGROUND

Natural gas is an important energy source that continues to increase in production and usage throughout the world. Before usage as a fuel or energy source, methane (CH₄), the desired component of natural gas, must often be separated from contaminant gases including carbon dioxide (CO₂) and hydrogen sulfide (H₂S). H₂S is a particularly toxic gas with high corrosion potential, and natural gas containing H₂S (also known as sour gas) must be processed to low ppm levels of H₂S before pipeline distribution.

Natural gas can be treated via natural gas “sweetening” using amine scrubbers and sorbents, though this costly technology often limits the economic feasibility of producing from various reservoirs. Polymeric membranes offer an energy-efficient alternative to sorption-based technology. Though membranes have been widely adopted, especially in natural gas separations, they often suffer from fundamental drawbacks including tradeoff relationships between separation efficiency (selectivity) and gas throughput/productivity (permeability), instability in realistic reservoirs, plasticization/swelling, and in the case of sour gas separations, tradeoff relationships between CO₂/CH₄ and H₂S/CH₄ separations. In general, membranes that are effective in H₂S/CH₄ separations generally have poor CO₂ performance, and many natural gas reservoirs contain both of these gases in high concentrations that need to be separated.

Therefore, there is a need for a membrane that is able to separate both CO₂ and H₂S from natural gas. There is also a need for a membrane with improved gas permeability and H₂S/CH₄ selectivity as compared to membranes typically used for natural gas separation.

### SUMMARY

Provided in the present disclosure is a polymer that includes:
a structural repeat unit of Formula (I):

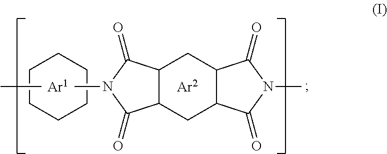

and
a structural repeat unit of Formula (II):

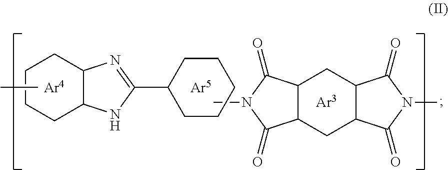

wherein:
Ar¹ is selected from:

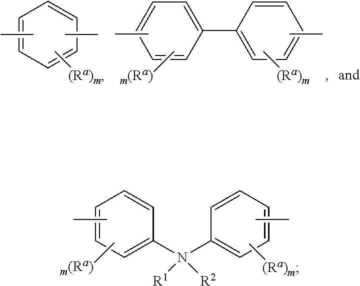

Ar² is selected from:

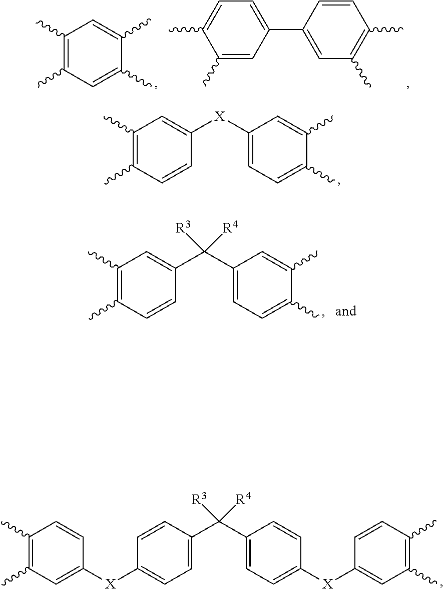

where [symbol] indicates the point of attachment to the

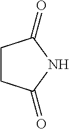

groups in Formula (I);
Ar³ is selected from:

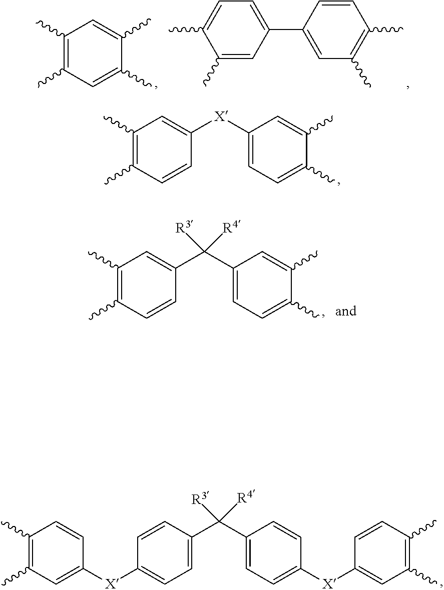

where [symbol] indicates the point of attachment to the

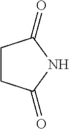

groups in Formula (II);
group

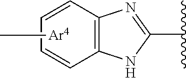

is selected from:

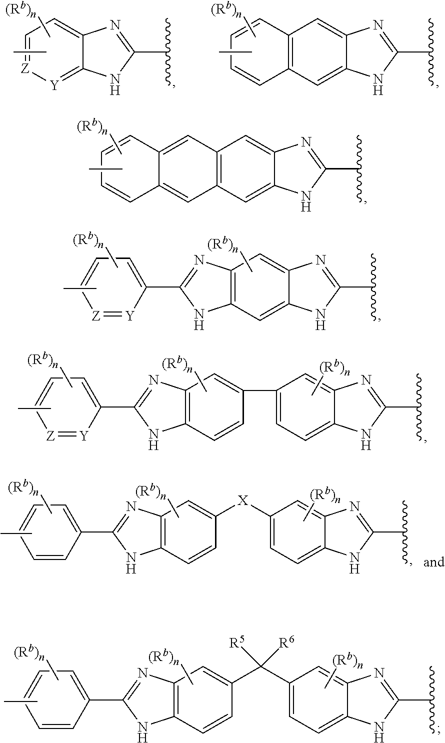

Ar⁵ is absent or is selected from:

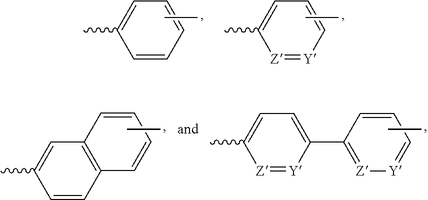

where [symbol] indicates the point of attachment to the

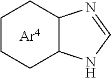

group in Formula (II);
X is NH, O, or S;
X′ is NH, O, or S;
Y is N or CH;
Y′ is N or CH;
Z is N or CH;
Z′ is N or CH;
R¹ and R² are each independently selected from H, C₁₋₆ alkyl, and C₁₋₆ haloalkyl;
or, R¹ and R², together with the C atom to which they are attached, form a 6-14 membered aromatic group or a 6-14 membered heteroaromatic group, wherein the 6-14 membered aromatic group or the 6-14 membered heteroaromatic group are optionally substituted with 1, 2, 3, or 4 independently selected R^{1A} substituents;
R³, R^{3′}, R⁴, and R^{4′} are each independently selected from H, C₁₋₆ alkyl, and C₁₋₆ haloalkyl;
or, R³ and R⁴ or R^{3′} and R^{4′}, together with the C atom to which they are attached, form a carbonyl (═O) group;
R⁵ and R⁶ are each independently selected from H, C₁₋₆ alkyl, and C₁₋₆ haloalkyl;
or, R⁵ and R⁶, together with the C atom to which they are attached, form a carbonyl (═O) group;
each R^{a} is independently selected from halo, OH, C₁₋₆ alkyl, and C₁₋₆ haloalkyl;
each R^{b} is independently selected from halo, OH, C₁₋₆ alkyl, and C₁₋₆ haloalkyl;
each R^{1A} is independently selected from halo, OH, C₁₋₆ alkyl, and C₁₋₆ haloalkyl;
m is an integer between 0 and 8; and
n is an integer between 0 and 10;
wherein the polymer comprises the structural repeat unit of Formula (I) and the structural repeat unit of Formula (II) in a molar ratio of about 1:1 to about 3:1.

In some embodiments, each R^{a} is independently selected from halo, OH, C₁₋₄ alkyl, and CF₃.

In some embodiments, Ar¹ is

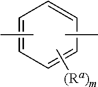

and m is an integer between 1 and 4. In some embodiments, each R^{a} is independently C₁₋₄ alkyl. In some embodiments, each R^{a} is methyl.

In some embodiments, Ar¹ is selected from:

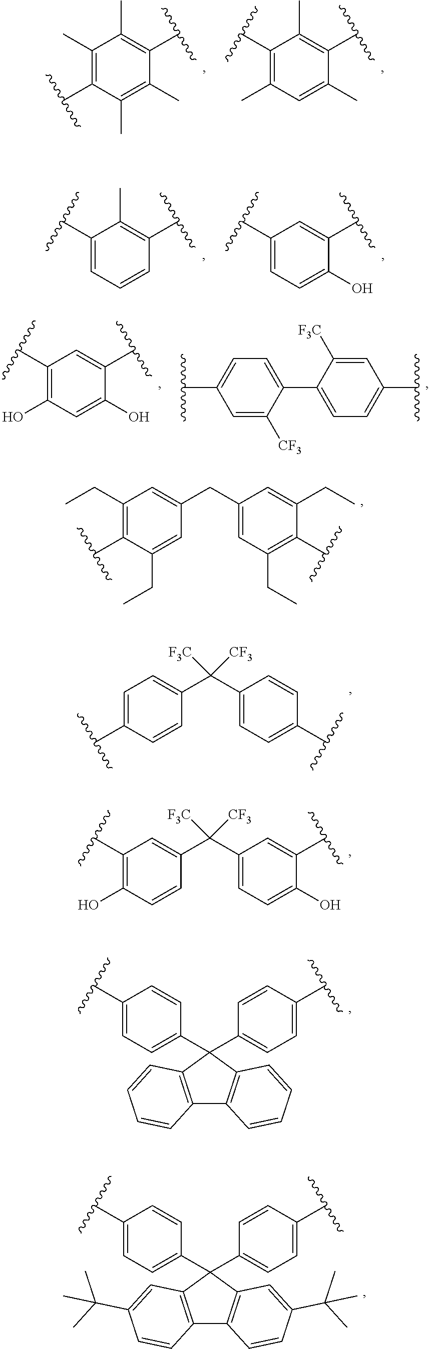

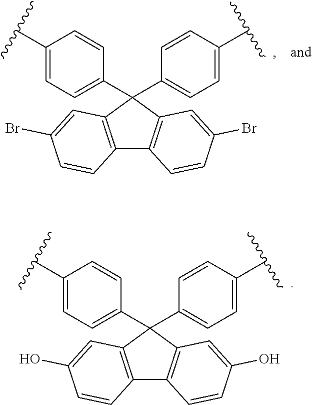 [SMILES: *c1ccc(C2(c3ccc(*)cc3)c3cc(Br)ccc3-c3ccc(Br)cc32)cc1 ; *c1ccc(C2(c3ccc(*)cc3)c3cc(O)ccc3-c3ccc(O)cc32)cc1]

In some embodiments, Ar¹ is

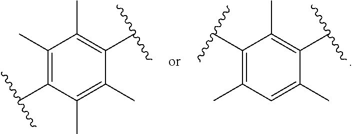

In some embodiments, X is O.

In some embodiments, R³ and R⁴ are each independently methyl or CF₃, or, R³ and R⁴, together with the C atom to which they are attached, form a carbonyl (═O) group.

In some embodiments, Ar² is selected from:

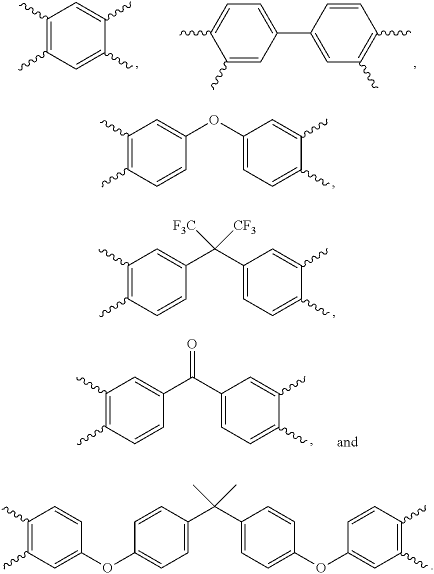

In some embodiments, Ar² is

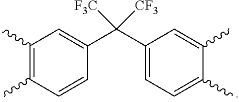

In some embodiments, X′ is O.

In some embodiments, R^{3′} and R^{4′} are each independently methyl or CF₃, or, R^{3′} and R^{4′}, together with the C atom to which they are attached, form a carbonyl (═O) group.

In some embodiments, Ar³ is selected from:

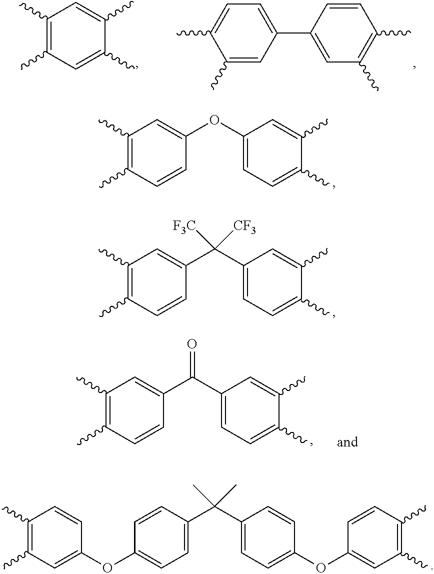

In some embodiments, Ar³ is

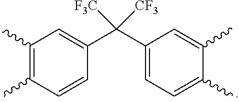

In some embodiments, the group

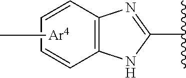

is selected from:

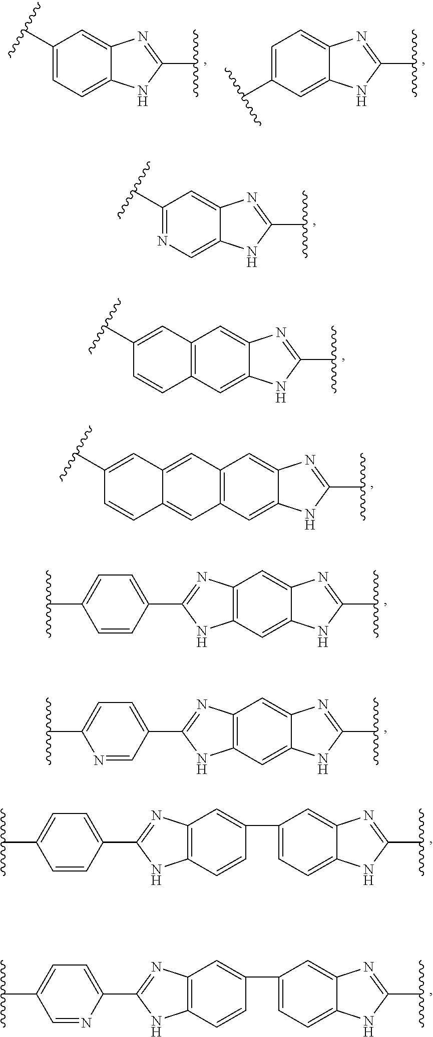

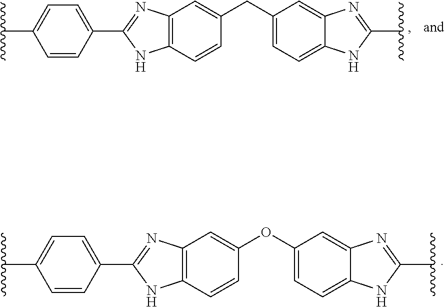 [SMILES: *c1ccc(-c2nc3cc(Cc4ccc5[nH]c(*)nc5c4)ccc3[nH]2)cc1 ; *c1ccc(-c2nc3cc(Oc4ccc5[nH]c(*)nc5c4)ccc3[nH]2)cc1]

In some embodiments, Ar⁵ is selected from:

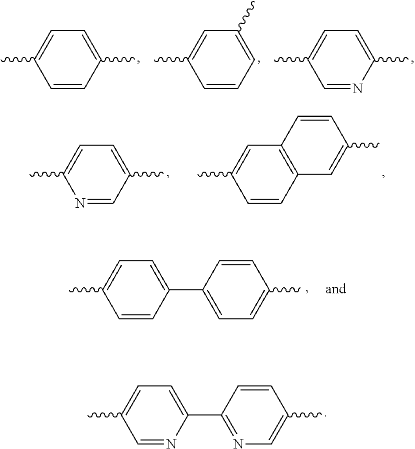

In some embodiments, the group

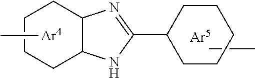

is selected from:

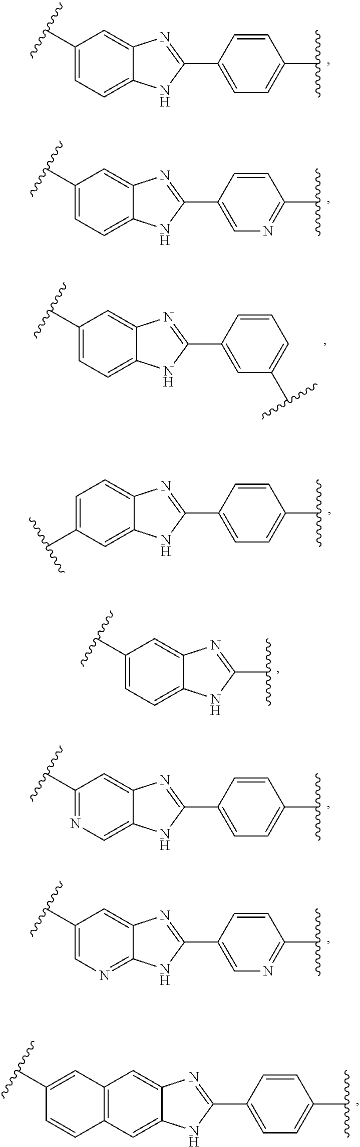

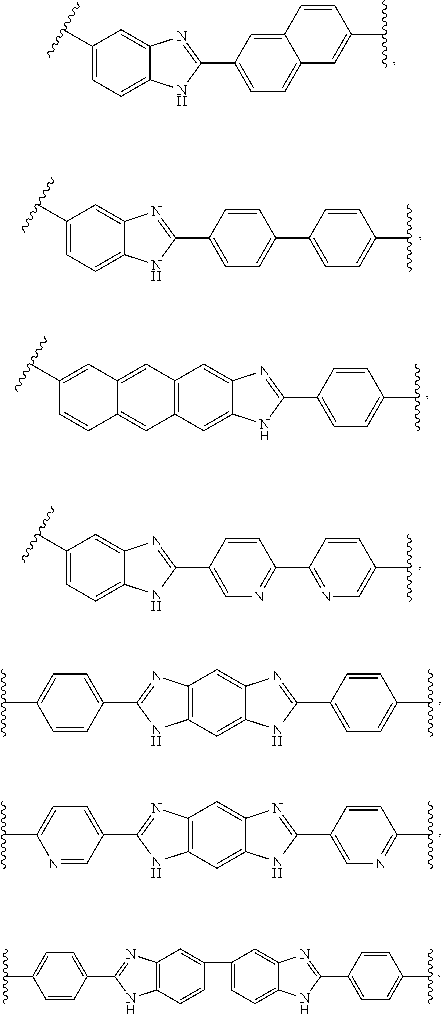

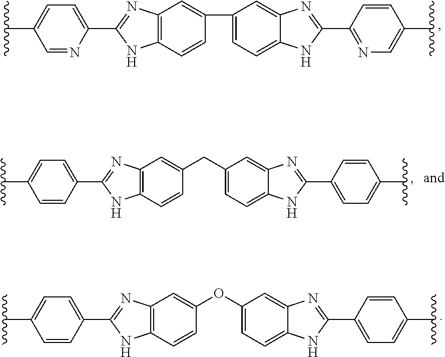 [SMILES: *c1ccc(-c2nc3cc(-c4ccc5[nH]c(-c6ccc(*)cn6)nc5c4)ccc3[nH]2)nc1 ; *c1ccc(-c2nc3cc(Cc4ccc5[nH]c(-c6ccc(*)cc6)nc5c4)ccc3[nH]2)cc1 ; *c1ccc(-c2nc3cc(Oc4ccc5[nH]c(-c6ccc(*)cc6)nc5c4)ccc3[nH]2)cc1]

In some embodiments, the structural repeat unit of Formula (I) is selected from:

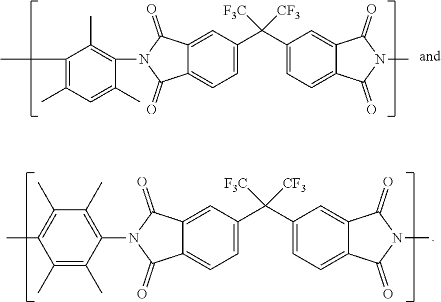

In some embodiments, the structural repeat unit of Formula (II) is:

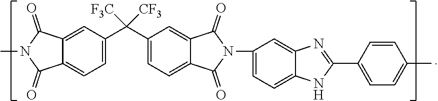

In some embodiments, the polymer has the structure:

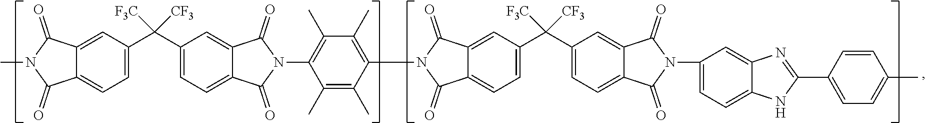

where the structural repeat unit of Formula (I) and the structural repeat unit of Formula (II) are present in a molar ratio of about 1:1, about 2:3, or about 3:1.

In some embodiments, the polymer has the structure:

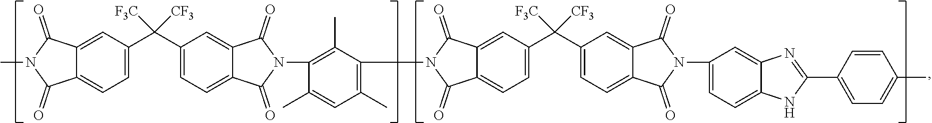

where the structural repeat unit of Formula (I) and the structural repeat unit of Formula (II) are present in a molar ratio of about 2:1 or about 3:1.

In some embodiments, the polymer has a number-average molecular weight of about 1,000 g/mol to about 1,000,000 g/mol.

Also provided is a membrane containing the polymer of the present disclosure. In some embodiments, the membrane contains about 99 wt % or less of the polymer.

Also provided in the present disclosure is a method for separating CO₂ and H₂S from natural gas. In some embodiments, the method includes introducing a natural gas stream to a membrane of the present disclosure; and separating the CO₂ and the H₂S from the natural gas stream.

In some embodiments of the method, the natural gas stream contains about 1 vol % to about 30 vol % of CO₂ and about 1 vol % to about 40 wt % of H₂S, prior to separating the CO₂ and the H₂S from the natural gas stream.

### DESCRIPTION OF DRAWINGS

FIG. 1 is a schematic representation of the “solution-diffusion” process.

FIG. 2 is the ¹H NMR spectrum of an exemplary 6FDA-DAM/PABZ (2:1) copolyimide in DMSO-d₆.

FIGS. 3A-3B are normalized FTIR spectra of a series of exemplary 6FDA-durene/PABZ (FIG. 3A) and 6FDA-DAM/PABZ (FIG. 3B) copolyimides.

FIGS. 4A-4B depict thermogravimetric analysis (TGA) and their first derivative (DTG) curves (FIG. 4A) and differential scanning calorimetric (DSC) traces (FIG. 4B) of exemplary copolyimides.

FIG. 5 depicts the CO₂/CH₄ permeability-selectivity “trade-off curve” of exemplary membranes.

FIGS. 6A-6C are graphs showing the change on the sweet mixed-gas CO₂ permeability (columns) and CO₂/CH₄ selectivity (curves) coefficients of exemplary PABZ-containing copolyimides at various feed pressures and 22° C. FIG. 6A shows an exemplary 6FDA-durene/PABZ (1:1) membrane; FIG. 6B shows an exemplary 6FDA-durene/PABZ (2:3) membrane; and FIG. 6C shows an exemplary 6FDA-durene/PABZ (3:1) membrane.

FIGS. 7A-7B are graphs showing the change on the sweet mixed-gas CO₂ permeability (columns) and CO₂/CH₄ selectivity (curves) coefficients of PABZ-containing copolyimides at different feed pressures and 22° C. FIG. 7A shows an exemplary 6FDA-DAM/PABZ (3:1) membrane; and FIG. 7B shows an exemplary 6FDA-DAM/PABZ (2:1) membrane.

FIGS. 8A-8B are graphs showing the change on the sweet mixed-gas CO₂ permeability (columns) and CO₂/CH₄ selectivity (curves) coefficients of PABZ-containing copolyimides at different operating temperature and 500 psi. FIG. 8A shows an exemplary 6FDA-DAM/PABZ (3:1) membrane; and FIG. 8B shows an exemplary 6FDA-DAM/PABZ (2:1) membrane.

### DETAILED DESCRIPTION

Provided in the present disclosure are polymeric membranes prepared from polyimides containing imidazole moieties for sour natural gas purification applications. Also provided in this disclosure are methods for preparing membranes containing imidazole moieties and methods for using the membranes in sour natural gas purification applications.

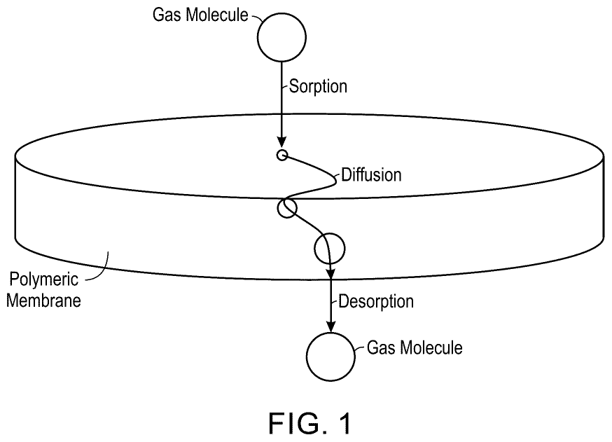

The separation of gas molecules through dense polymeric membranes proceeds according to the “solution-diffusion” model, where a gas molecule sorbs into the surface of membrane polymeric material, then diffuses through the thin membrane matrix, to finally desorb to the downstream side of the membrane (FIG. 1).

One way of improving membrane performance is by tailoring the properties of the polymeric material forming the membrane by increasing the dynamic free volume of the membrane by adding bulky groups or a heteroatom that is larger than a carbon atom and/or improving the gas-polymer affinity by increasing the polarity within the polymer backbone. This methodology can be used to allow the polymeric material to deal with each gas molecule in a distinct manner. For example, the dynamic free volume within the membrane matrix can separate the gas molecules based on the difference of their sizes (i.e., kinetic diameters, Dₖ) according to a kinetic phenomenon (i.e., rate of diffusion), since methane (Dₖ=3.80 Å, the main component of natural gas) is larger in size than the undesired existent impurities in natural gas (i.e., Dₖ=3.30 A for CO₂ and Dₖ=3.60 Å for H₂S). On the other hand, improving the gas-polymer affinity allows better solubility of polar gas molecules, such as H₂S, or molecules containing polar bonds, such as CO₂, to favor their permeation through the membrane matrix, while not influencing the transport of methane.

Amine groups (primary, secondary, or tertiary) are polar in nature and can participate in strong intermolecular interactions, such as hydrogen bonding, and dipole-dipole interactions. Without wishing to be bound by any particular theory, it is believed that these features of amine groups can be beneficial for polymeric membranes used for high pressure gas separation because the polar nature of amine groups increases the affinity of acid gases to polymeric chains (H₂S is a polar molecule, and CO₂ is a non-polar molecule with polar bonds), and the polar nature of amine groups increases the polymer's interchain interactions, which tends to reduce or even eliminate plasticization of membranes at elevated feed pressures.

Thus, provided in the present disclosure are polymeric membranes with improved performance for use in natural gas separation applications. Use of the membranes of the present disclosure allow for enhanced productivity, efficiency, and resistance to plasticization at elevated operational conditions of pressure and temperature during sweet and/or sour mixed-gas separation, which can reduce the capital expenditure (CAPEX) and operational expenditure (OPEX) of the membrane-based natural gas purification process.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting. All publications, patent applications, patents, sequences, database entries, and other references mentioned in this document are incorporated by reference in their entirety. In case of conflict, the present specification, including definitions, will control.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

In the methods described in this disclosure, the acts can be carried out in any order, except when a temporal or operational sequence is explicitly recited. Furthermore, specified acts can be carried out concurrently unless explicit claim language recites that they be carried out separately.

For example, a claimed act of doing X and a claimed act of doing Y can be conducted simultaneously within a single operation, and the resulting process will fall within the literal scope of the claimed process.

The terms “sour” or “sour gas” mean that the gas stream contains hydrogen sulfide (H₂S).

As used in the present disclosure, the term “monomer unit,” used in reference to a polymer, refers to a monomer, or residue of a monomer, that has been incorporated into at least a portion of the polymer.

As used in the present disclosure, the term “polymerization product,” used in reference to one or more monomers, refers to a polymer that can be formed by a chemical reaction of the one or more monomers. For example, a “polymerization product” of acrylic acid is a polymer containing acrylic acid monomer units.

As used in the present disclosure, the term “C-m alkyl” refers to any linear or branched saturated hydrocarbon group having n to m carbons. Alkyl groups include, but are not limited to, methyl, ethyl, propyl such as propan-1-yl, propan-2-yl (iso-propyl), butyl such as butan-1-yl, butan-2-yl (sec-butyl), 2-methyl-propan-1-yl (iso-butyl), 2-methyl-propan-2-yl (t-butyl), pentyl, hexyl, octyl, dectyl, and the like. As used in the present disclosure, the term “alkylene” refers to a bivalent alkyl.

As used in the present disclosure, the term “halo” refers to —F, —Cl, —Br, or —I.

### Polymers

The polymers of the present disclosure contain aromatic imidazole-based moieties, such as aromatic imidazole diamines and aromatic diimidazole diamines. The imidazole moieties contain polar secondary amine functional groups, that can serve to simultaneously improve the solubility and diffusivity of gas molecules through a polymeric matrix membrane containing the imidazole moieties, while enhancing the possibility of interchain interactions through hydrogen bonding.

Diamine imidazole monomer

The diamine imidazole monomers of the present disclosure are aromatic, which means that the primary amine groups are located on aromatic rings connected directly or through covalent bonds to the imidazole central ring. The diamine imidazole monomers that can be used in the polymers and membranes of the present disclosure have the structure (1):

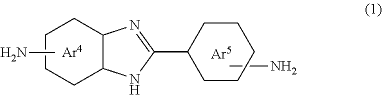

where the primary amine groups can be attached to any possible available positions of the aromatic rings attached to the central imidazole ring of the monomer (1). The aromatic moieties (Ar⁴ and Ar⁵) can be any type of aromatic moiety. Examples of suitable aromatic moieties include, but are not limited to, monocyclic rings (e.g., benzene), bicyclic moieties (e.g., naphthalene), and polycyclic moieties (e.g., anthracene). The aromatic moieties (Ar⁴ and Ar⁵) can be unsubstituted or can be substituted at one or multiple available positions with any suitable group.

For example, the diamine imidazole monomer can have the structure:

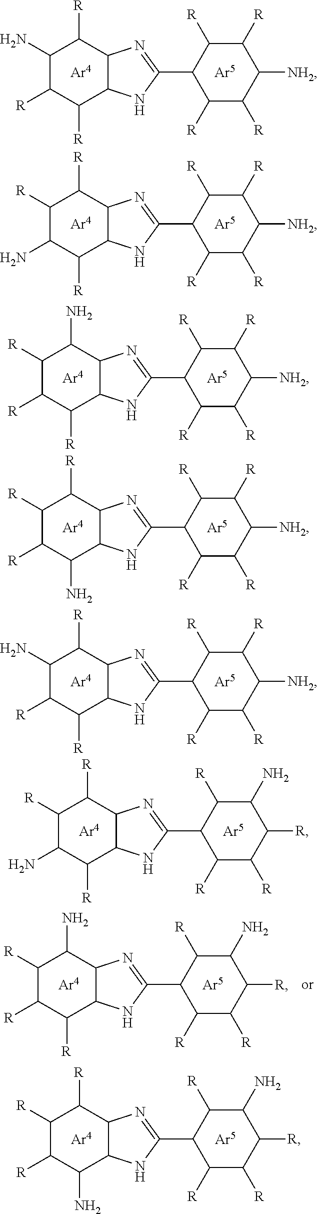

where R can be any suitable substituent.

Examples of diamine imidazole monomers include, but are not limited to:

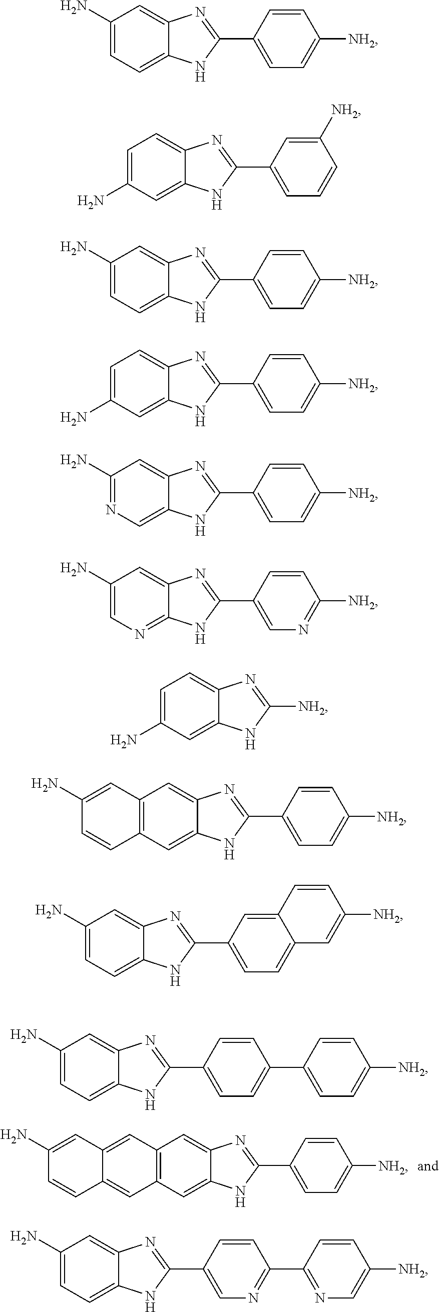

each of which can be substituted with one or more R groups.

In some embodiments, the diamine imidazole monomer is a diamine diimidazole monomer having the general structure:

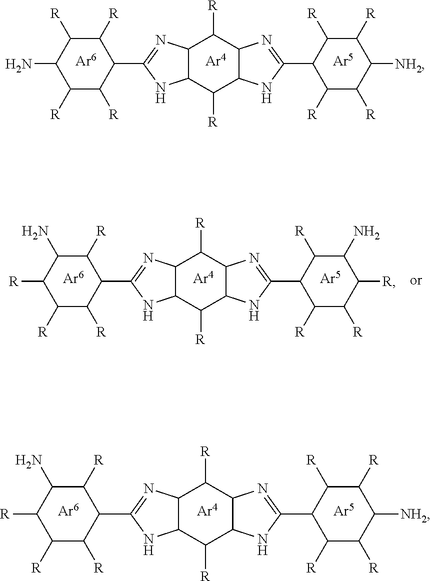

where R can be any suitable substituent.

Examples of suitable diamine diimidazole monomers include, but are not limited to:

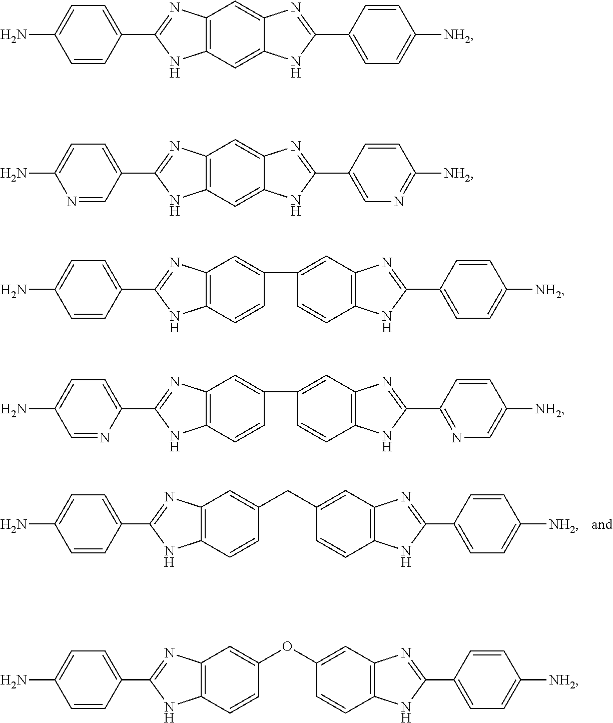

each of which can be substituted with one or more R groups.

In some embodiments, the diamine imidazole monomer is 5-amino-2-(4-aminophenyl)benzimidazole (PABZ), having the structure:

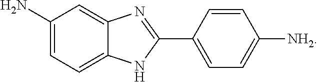 [SMILES: Nc1ccc(-c2nc3cc(N)ccc3[nH]2)cc1]

Dianhydride monomer

The dianhydride monomers of the present disclosure are aromatic. The aromatic dianyhydride monomers that can be used in the polymers and membranes of the present disclosure have the structure (2):

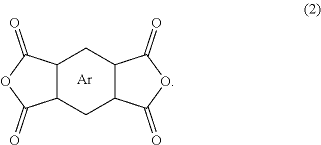

The aromatic moiety (Ar) can be any type of aromatic moiety. Examples of suitable aromatic moieties include, but are not limited to, monocyclic rings (e.g., benzene), bicyclic moieties (e.g., naphthalene), and polycyclic moieties (e.g., anthracene). In some embodiments, the aromatic moiety Ar includes two aromatic groups linked via a single atom (e.g., NH, O, S) or a linker, such as an alkyl linker. The aromatic moiety (Ar) can be unsubstituted or can be substituted at one or multiple available positions with any suitable group.

Examples of dianhydride monomers include, but are not limited to:

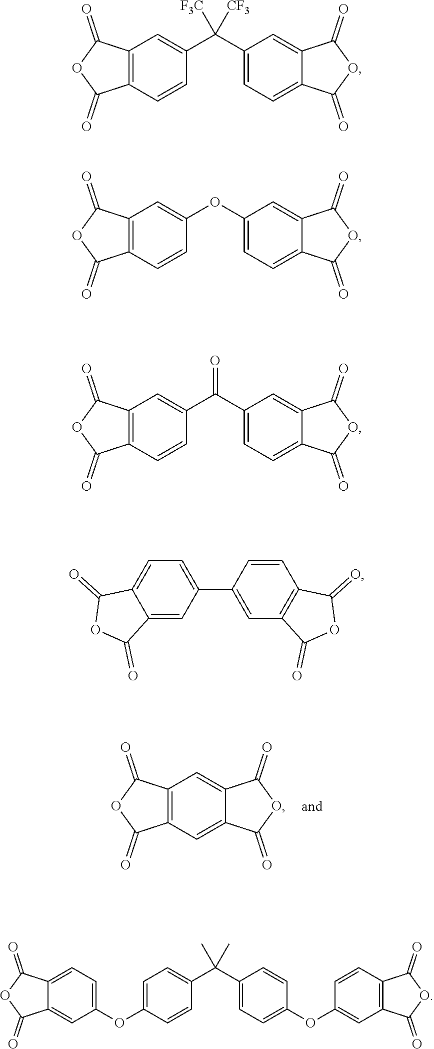 [SMILES: O=C1OC(=O)c2cc(C(c3ccc4c(c3)C(=O)OC4=O)(C(F)(F)F)C(F)(F)F)ccc21 ; O=C1OC(=O)c2cc(Oc3ccc4c(c3)C(=O)OC4=O)ccc21 ; O=C(c1ccc2c(c1)C(=O)OC2=O)c1ccc2c(c1)C(=O)OC2=O ; O=C1OC(=O)c2cc(-c3ccc4c(c3)C(=O)OC4=O)ccc21 ; O=c1oc(=O)c2cc3c(=O)oc(=O)c3cc12 ; CC(C)(c1ccc(Oc2ccc3c(c2)C(=O)OC3=O)cc1)c1ccc(Oc2ccc3c(c2)C(=O)OC3=O)cc1]

In some embodiments of the copolymers described in the present disclosure, two different dianhydride monomers are incorporated into the copolymer.

In some embodiments, the dianhydride monomer is 5,5′-(perfluoropropane-2,2-diyl)bis(isobenzofuran-1,3-dione) (6FDA) having the structure:

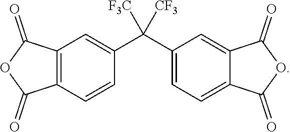 [SMILES: O=C1OC(=O)c2cc(C(c3ccc4c(c3)C(=O)OC4=O)(C(F)(F)F)C(F)(F)F)ccc21]

Aromatic diamine

The diamines of the present disclosure are aromatic. The aromatic diamines that can be used in the polymers and membranes of the present disclosure have the structure (3):

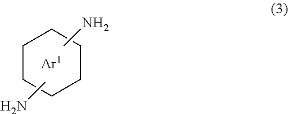

The aromatic moiety (Ar¹) can be any type of aromatic moiety. Examples of suitable aromatic moieties include, but are not limited to, monocyclic rings (e.g., benzene), bicyclic moieties (e.g., naphthalene), and polycyclic moieties (e.g., anthracene). In some embodiments, the aromatic moiety Ar¹ includes two aromatic groups linked via a single atom (e.g., NH, O, S) or a linker, such as an alkyl linker. The aromatic moiety (Ar¹) can be unsubstituted or can be substituted at one or multiple available positions with any suitable group.

The aromatic diamine monomer used in the preparation of the copolyimides of the present disclosure can be used to provide polymer segments that can tailor the properties of the targeted polymeric materials. Examples of aromatic diamine monomers include, but are not limited to:

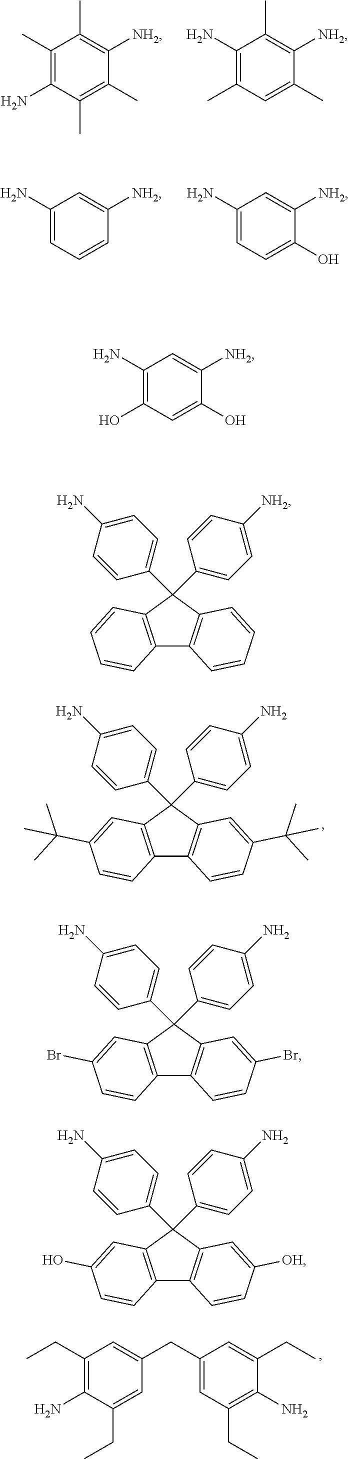

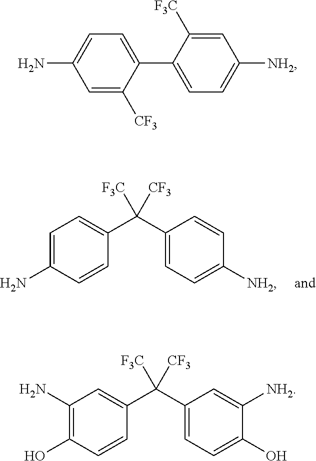 [SMILES: Nc1ccc(-c2ccc(N)cc2C(F)(F)F)c(C(F)(F)F)c1 ; Nc1ccc(C(c2ccc(N)cc2)(C(F)(F)F)C(F)(F)F)cc1 ; "and" ; Nc1cc(C(c2ccc(O)c(N)c2)(C(F)(F)F)C(F)(F)F)ccc1O]

In some embodiments, the aromatic diamine monomer is 2,3,5,6-tetramethylbenzene-1,4-diamine (durene) having the structure:

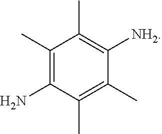

In some embodiments, the aromatic diamine monomer is 2,4,6-trimethylbenzene-1,3-diamine (DAM) having the structure:

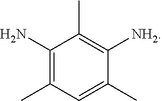

### Copolymers

As shown in Scheme 1, the diamine imidazole monomers (1) can be reacted with a dianhydride monomer (2a) to afford the compound of Formula (II), an imidazole-based homopolyimide.

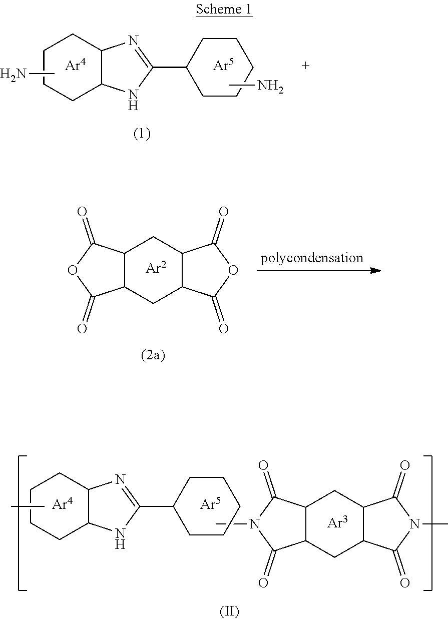

Scheme 2 shows the general synthetic route for preparing random or block imidazole-based copolyimides, where diamine imidazole monomer (1) is reacted with dianhydride monomer (2a) and other dianhydride monomers (2b) and aromatic diamines (3). The copolyimides are prepared by using an imidazole-based monomer and a dianhydride monomer in addition to another diamine comonomer. Copolymerization is used in order to combine the gas permeation properties of two separate homopolymers into one structure (i.e., a copolymer). The second diamine monomer is chosen to complement the properties provided by the imidazole-based homopolyimide to either improve the permeability or selectivity of the copolyimide membrane. In some embodiments, for natural gas purification, it is desired to improve the permeability of impurities, such as carbon dioxide (CO₂) and hydrogen sulfide (H₂S), and the membrane selectivities (CO₂/CH₄ and H₂S/CH₄) toward the main hydrocarbon constituting the natural gas, i.e., methane (CH₄). In some embodiments, it is desired to increase the plasticization resistance of polymeric membranes during high pressure mixed-gas separation. The polar secondary amine group is intended to form a hydrogen bond or dipole-dipole type interaction between the polymeric chains which limits their mobility under harsh temperature and pressure separation conditions. In some embodiments, the polymeric membranes of the present disclosure exhibit improved permeation properties and plasticization resistance during mixed-gas separation at high feed pressures.

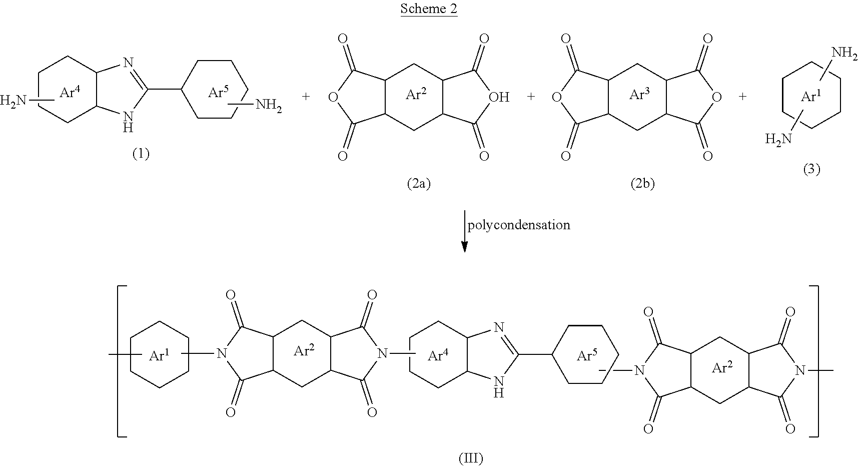

The copolyimides prepared according to the schemes described in the present disclosure are used to prepare polymeric membranes with improved sweet and/or sour mixed gas separation properties when used for natural gas purification applications. Sour gas refers to a gas stream that contains hydrogen sulfide (H₂S), where membranes used for sour gas applications are prone to plasticization due to the high affinity of H₂S molecules to polymeric materials due to the polar nature of the H₂S molecules.

The synthetic methodology described in the present disclosure allows for the preparation of a large variety of imidazole-based polymers including, but not limited to, homopolymers, random copolymers, block copolymers, terpolymers, and alternating copolymers.

Thus, provided in the present disclosure are polymers that contain a structural repeat unit of Formula (I):

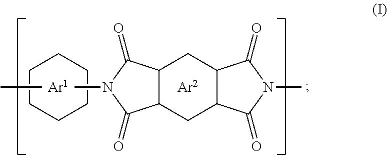

and
a structural repeat unit of Formula (II):

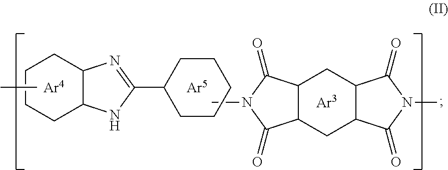

wherein:
Ar¹ is selected from:

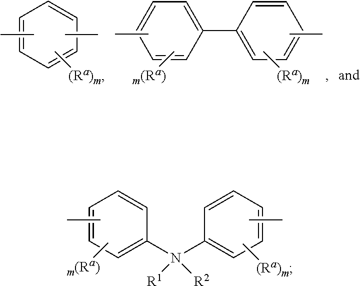

Ar² is selected from:

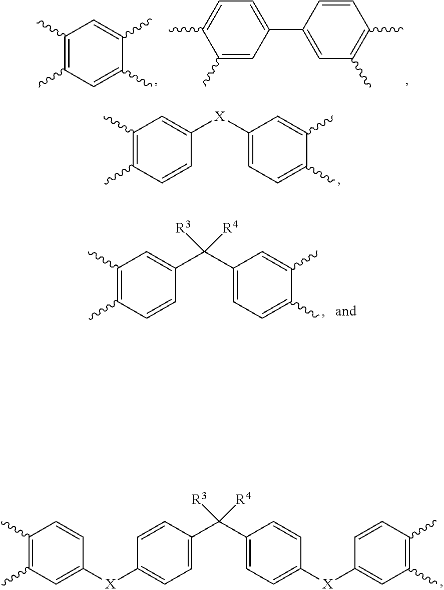

where [symbol] indicates the point of attachment to the

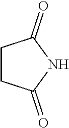

groups in Formula (I);
Ar³ is selected from:

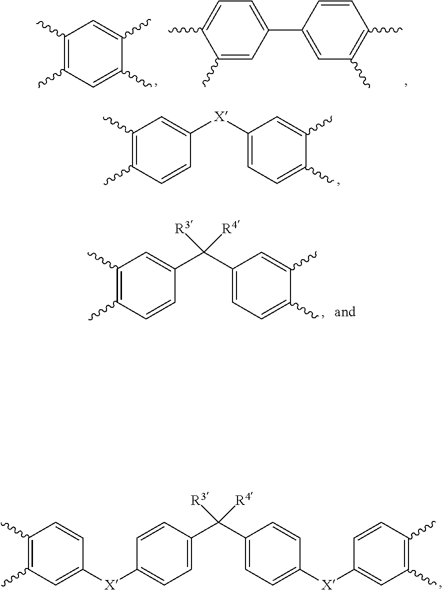

where [symbol] indicates the point of attachment to the

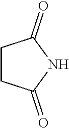

groups in Formula (II);
group

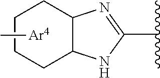

is selected from:

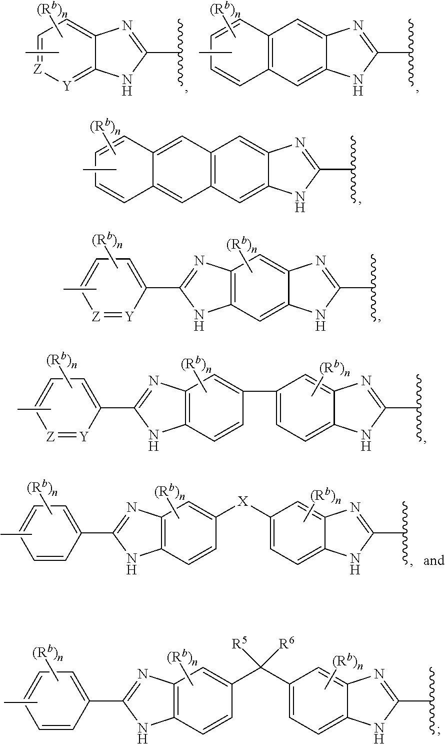

Ar⁵ is absent or is selected from:

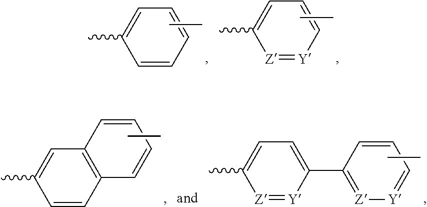

where [symbol] indicates the point of attachment to the

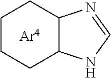

group in Formula (II);
X is NH, O, or S;
X′ is NH, O, or S;
Y is N or CH;
Y′ is N or CH;
Z is N or CH;
Z′ is N or CH;
R¹ and R² are each independently selected from H, C₁₋₆ alkyl, and C₁₋₆ haloalkyl;
or, R¹ and R², together with the C atom to which they are attached, form a 6-14 membered aromatic group or a 6-14 membered heteroaromatic group, wherein the 6-14 membered aromatic group or the 6-14 membered heteroaromatic group are optionally substituted with 1, 2, 3, or 4 independently selected R^{1A} substituents;
R³, R^{3′}, R⁴, and R^{4′} are each independently selected from H, C₁₋₆ alkyl, and C₁₋₆ haloalkyl;
or, R³ and R⁴ or R^{3′} and R^{4′}, together with the C atom to which they are attached, form a carbonyl (═O) group;
R⁵ and R⁶ are each independently selected from H, C₁₋₆ alkyl, and C₁₋₆ haloalkyl;
or, R⁵ and R⁶, together with the C atom to which they are attached, form a carbonyl (═O) group;
each R^{a} is independently selected from halo, OH, C₁₋₆ alkyl, and C₁₋₆ haloalkyl;
each R^{b} is independently selected from halo, OH, C₁₋₆ alkyl, and C₁₋₆ haloalkyl;
each R^{1A} is independently selected from halo, OH, C₁₋₆ alkyl, and C₁₋₆ haloalkyl;
m is an integer between 0 and 8; and
n is an integer between 0 and 10;
wherein the polymer comprises the structural repeat unit of Formula (I) and the structural repeat unit of Formula (II) in a molar ratio of about 1:1 to about 3:1.

In some embodiments, Ar¹ is

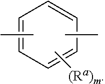

In some embodiments, Ar¹ is

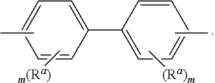

In some embodiments, Ar¹ is

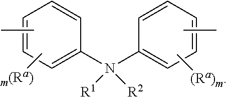

In some embodiments, R¹ is H. In some embodiments, R¹ is C₁₋₆ alkyl. In some embodiments, R¹ is C₁₋₃ alkyl. In some embodiments, R¹ is methyl. In some embodiments, R¹ is C₁₋₆ haloalkyl. In some embodiments, R¹ is C₁₋₃ haloalkyl. In some embodiments, R¹ is CF₃.

In some embodiments, R² is H. In some embodiments, R² is C₁₋₆ alkyl. In some embodiments, R² is C₁₋₃ alkyl. In some embodiments, R² is methyl. In some embodiments, R² is C₁₋₆ haloalkyl. In some embodiments, R² is C₁₋₃ haloalkyl. In some embodiments, R² is CF₃.

In some embodiments, R¹ and R² are the same. In some embodiments, R¹ and R² are different. In some embodiments R¹ and R² are each H. In some embodiments, R¹ and R² are each CF₃.

In some embodiments, R¹ and R², together with the C atom to which they are attached, form a 6-14 membered aromatic group or a 6-14 membered heteroaromatic group, wherein the 6-14 membered aromatic group or the 6-14 membered heteroaromatic group are optionally substituted with 1, 2, 3, or 4 independently selected R^{1A} substituents. In some embodiments, R¹ and R², together with the C atom to which they are attached, form a 12-14 membered aromatic group optionally substituted with 1 or 2 independently selected R^{1A} substituents. In some embodiments, R¹ and R², together with the C atom to which they are attached, form a 13 membered aromatic group optionally substituted with 1 or 2 independently selected R^{1A} substituents. In some embodiments, R¹ and R², together with the C atom to which they are attached, form a 13 membered aromatic group 9,9-bis(4-aminophenyl)fluorene (CARDO) having the structure

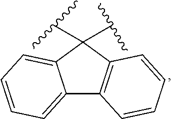 [SMILES: *C1(*)c2ccccc2-c2ccccc21]

optionally substituted with 1 or 2 independently selected R^{1A} substituents.

In some embodiments, each R^{1A} is halo. In some embodiments, each R^{1A} is bromo. In some embodiments, each R^{1A} is OH. In some embodiments, each R^{1A} is C₁₋₆ alkyl. In some embodiments, each R^{1A} is C₁₋₄ alkyl. In some embodiments, each R^{1A} is tert-butyl. In some embodiments, each R^{1A} is C₁₋₆ haloalkyl. In some embodiments, each R^{1A} is C₁₋₃ haloalkyl.

In some embodiments, R¹ and R², together with the C atom to which they are attached, form a CARDO having the structure

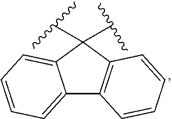 [SMILES: *C1(*)c2ccccc2-c2ccccc21]

that is substituted with 2 independently selected R^{1A} substituents. In some embodiments, each R^{1A} is halo. In some embodiments, each R^{1A} is bromo. In some embodiments, each R^{1A} is OH. In some embodiments, each R^{1A} is C₁₋₄ alkyl. In some embodiments, each R^{1A} is tert-butyl. In some embodiments, R¹ and R², together with the C atom to which they are attached, form the group having the structure

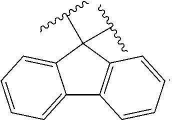 [SMILES: *C1(*)c2ccccc2-c2ccccc21]

In some embodiments, R¹ and R², together with the C atom to which they are attached, form the group having the structure

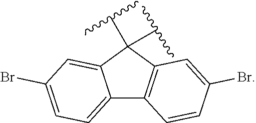 [SMILES: *C1(*)c2cc(Br)ccc2-c2ccc(Br)cc21]

In some embodiments, R¹ and R², together with the C atom to which they are attached, form the group having the structure

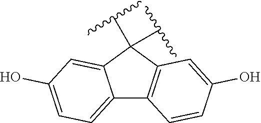 [SMILES: *C1(*)c2cc(O)ccc2-c2ccc(O)cc21]

In some embodiments, R¹ and R², together with the C atom to which they are attached, form the group having the structure

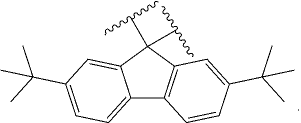 [SMILES: *C1(*)c2cc(C(C)(C)C)ccc2-c2ccc(C(C)(C)C)cc21]

In some embodiments, each R^{a} is halo. In some embodiments, each R^{a} is bromo. In some embodiments, each R^{a} is OH. In some embodiments, each R^{a} is C₁₋₆ alkyl. In some embodiments, each R^{a} is C₁₋₄ alkyl. In some embodiments, each R^{a} is tert-butyl. In some embodiments, each R^{a} is ethyl. In some embodiments, each R^{a} is methyl. In some embodiments, each R^{a} is C₁₋₆ haloalkyl. In some embodiments, each R^{a} is C₁₋₃ haloalkyl. In some embodiments, each R^{a} is CF₃.

In some embodiments, m is 0. In some embodiments, m is 1. In some embodiments, m is 2. In some embodiments, m is 3. In some embodiments, m is 4. In some embodiments, m is 5. In some embodiments, m is 6. In some embodiments, m is 7. In some embodiments, m is 8.

In some embodiments, Ar¹ is

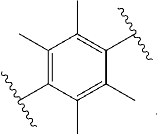 [SMILES: *c1c(C)c(C)c(*)c(C)c1C]

In some embodiments, Ar¹ is

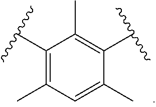

In some embodiments, Ar² is

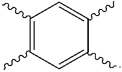

In some embodiments, Ar² is

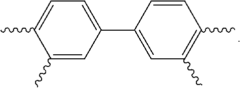

In some embodiments, Ar² is

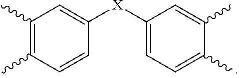

In some embodiments, Ar² is

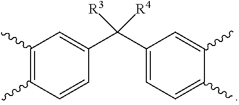

In some embodiments, Ar² is

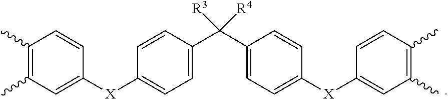

In some embodiments, X is O.

In some embodiments, R³ is H. In some embodiments, R³ is C₁₋₆ alkyl. In some embodiments, R³ is C₁₋₃ alkyl. In some embodiments, R³ is methyl. In some embodiments, R³ is C₁₋₆ haloalkyl. In some embodiments, R³ is C₁₋₃ haloalkyl. In some embodiments, R³ is CF₃.

In some embodiments, R⁴ is H. In some embodiments, R⁴ is C₁₋₆ alkyl. In some embodiments, R⁴ is C₁₋₃ alkyl. In some embodiments, R⁴ is methyl. In some embodiments, R⁴ is C₁₋₆ haloalkyl. In some embodiments, R⁴ is C₁₋₃ haloalkyl. In some embodiments, R⁴ is CF₃.

In some embodiments, R³ and R⁴ are the same. In some embodiments, R³ and R⁴ are different. In some embodiments R³ and R⁴ are each H. In some embodiments R³ and R⁴ are each methyl. In some embodiments, R³ and R⁴ are each CF₃.

In some embodiments, R³ and R⁴, together with the C atom to which they are attached, form a carbonyl (═O) group.

In some embodiments, Ar² is

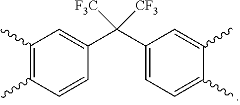

In some embodiments, Ar³ is

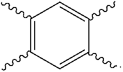

In some embodiments, Ar³ is

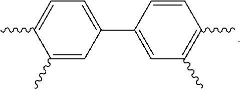

In some embodiments, Ar³ is

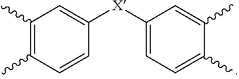

In some embodiments,

Ar³ is

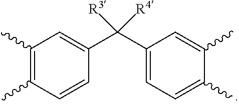

In some embodiments, Ar³ is

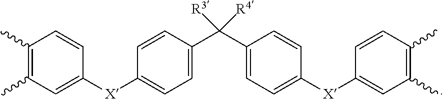

In some embodiments, X′ is O.

In some embodiments, R^{3′} is H. In some embodiments, R^{3′} is C₁₋₆ alkyl. In some embodiments, R^{3′} is C₁₋₃ alkyl. In some embodiments, R^{3′} is methyl. In some embodiments, R^{3′} is C₁₋₆ haloalkyl. In some embodiments, R^{3′} is C₁₋₃ haloalkyl. In some embodiments, R^{3′} is CF₃.

In some embodiments, R^{4′} is H. In some embodiments, R^{4′} is C₁₋₆ alkyl. In some embodiments, R^{4′} is C₁₋₃ alkyl. In some embodiments, R^{4′} is methyl. In some embodiments, R^{4′} is C₁₋₆ haloalkyl. In some embodiments, R^{4′} is C₁₋₃ haloalkyl. In some embodiments, R^{4′} is CF₃.

In some embodiments, R^{3′} and R^{4′} are the same. In some embodiments, R^{3′} and R^{4′} are different. In some embodiments R^{3′} and R^{4′} are each H. In some embodiments R^{3′} and R^{4′} are each methyl. In some embodiments, R^{3′} and R^{4′} are each CF₃.

In some embodiments, R^{3′} and R^{4′}, together with the C atom to which they are attached, form a carbonyl (═O) group.

In some embodiments, Ar³ is

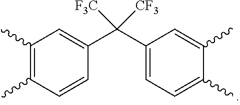

In some embodiments, the group

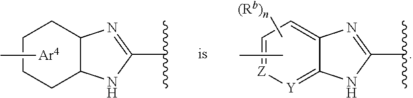

In some embodiments, the group

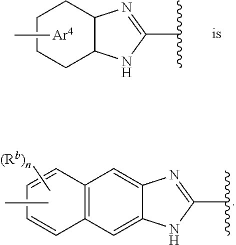

In some embodiments, the group

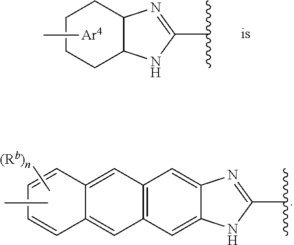

In some embodiments, the group

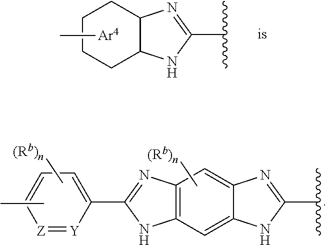

In some embodiments, the group

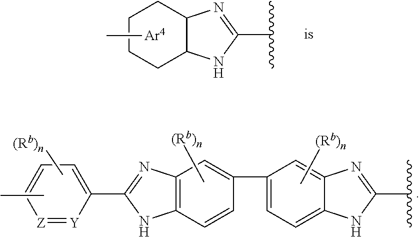

In some embodiments, the group

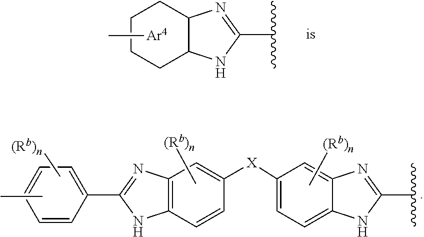

In some embodiments, the group

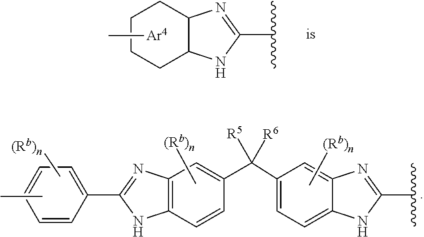

In some embodiments, Z is N. In some embodiments, Z is CH.

In some embodiments, Y is N. In some embodiments, Y is CH.

In some embodiments, Z is N and Y is N. In some embodiments, Z is N and Y is CH. In some embodiments, Z is CH and Y is CH. In some embodiments, Z is CH and Y is N.

In some embodiments, R⁵ is H. In some embodiments, R⁵ is C₁₋₆ alkyl. In some embodiments, R⁵ is C₁₋₃ alkyl. In some embodiments, R⁵ is methyl. In some embodiments, R⁵ is C₁₋₆ haloalkyl. In some embodiments, R⁵ is C₁₋₃ haloalkyl. In some embodiments, R⁵ is CF₃.

In some embodiments, R⁶ is H. In some embodiments, R⁶ is C₁₋₆ alkyl. In some embodiments, R⁶ is C₁₋₃ alkyl. In some embodiments, R⁶ is methyl. In some embodiments, R⁶ is C₁₋₆ haloalkyl. In some embodiments, R⁶ is C₁₋₃ haloalkyl. In some embodiments, R⁶ is CF₃.

In some embodiments, R⁵ and R⁶ are the same. In some embodiments, R⁵ and R⁶ are different. In some embodiments R⁵ and R⁶ are each H. In some embodiments R⁵ and R⁶ are each methyl. In some embodiments, R⁵ and R⁶ are each CF₃.

In some embodiments, R⁵ and R⁶, together with the C atom to which they are attached, form a carbonyl (═O) group.

In some embodiments, each R^{b} is halo. In some embodiments, each R^{b} is OH. In some embodiments, each R^{b} is C₁₋₆ alkyl. In some embodiments, each R^{b} is C₁₋₄ alkyl. In some embodiments, each R^{b} is methyl. In some embodiments, each R^{b} is C₁₋₆ haloalkyl. In some embodiments, each R^{b} is C₁₋₃ haloalkyl. In some embodiments, each R^{b} is CF₃.

In some embodiments, n is 0. In some embodiments, n is 1. In some embodiments, n is 2. In some embodiments, n is 3. In some embodiments, n is 4. In some embodiments, n is 5. In some embodiments, n is 6. In some embodiments, n is 7. In some embodiments, n is 8. In some embodiments, n is 9. In some embodiments, n is 10.

In some embodiments, Ar⁵ is absent. In some embodiments, Ar⁵ is

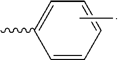

In some embodiments, Ar⁵ is

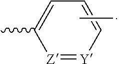

In some embodiments, Ar⁵ is

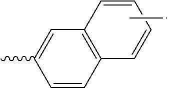

In some embodiments, Ar⁵ is

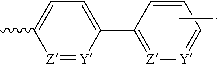

In some embodiments, Z′ is N. In some embodiments, Z′ is CH.

In some embodiments, Y′ is N. In some embodiments, Y′ is CH.

In some embodiments, Z‘ is N and Y’ is N. In some embodiments, Z‘ is N and Y’ is CH.

In some embodiments, Z‘ is CH and Y’ is CH. In some embodiments, Z‘ is CH and Y’ is N.

In some embodiments, the group

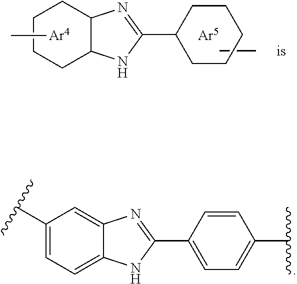

In some embodiments, the group

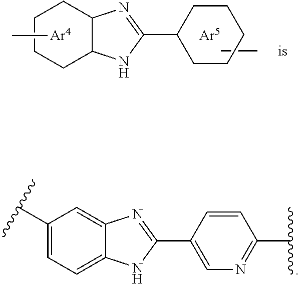

In some embodiments, the group

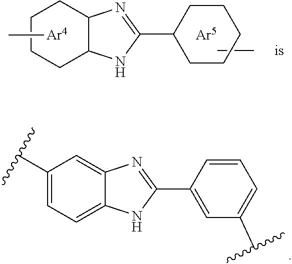

In some
embodiments, the group

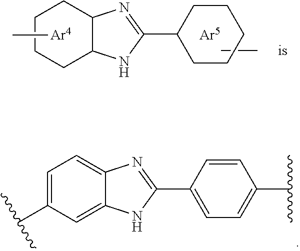

In some embodiments, the group

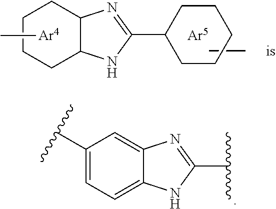

In some embodiments, the group

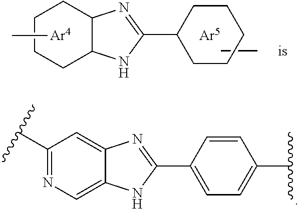

In some embodiments, the group

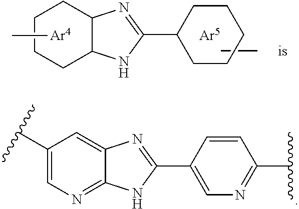

In some embodiments, the group

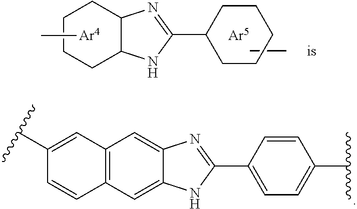

In some embodiments, the group

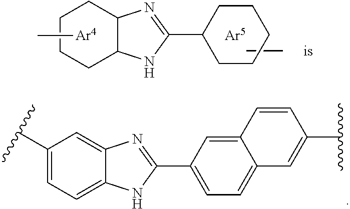

In some embodiments, the group

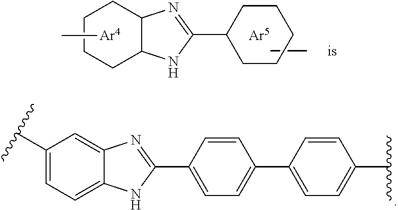

In some embodiments, the group

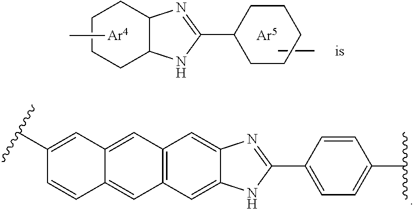

In some embodiments, the group

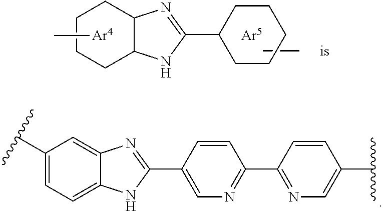

In some embodiments, the group

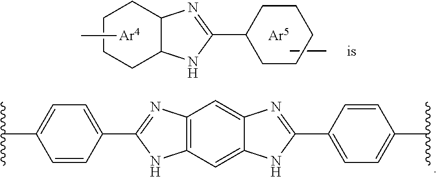

In some embodiments, the group

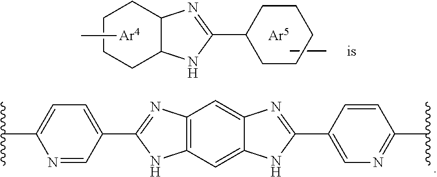

In some embodiments, the group

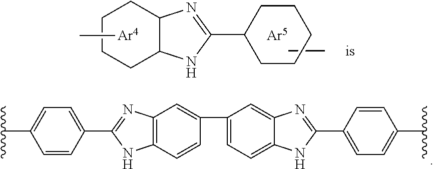

In some embodiments, the group

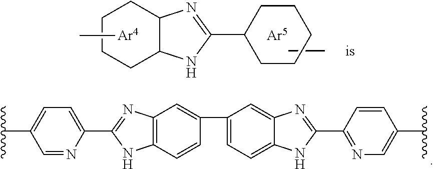

In some embodiments, the group

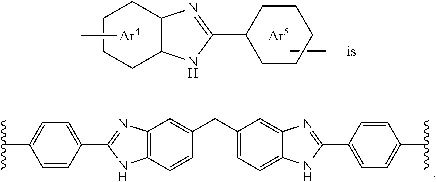

In some embodiments, the group

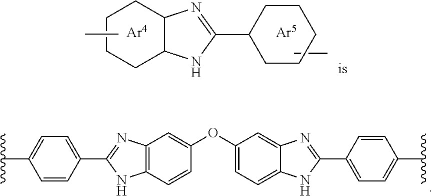

In some embodiments, the structural repeat unit of Formula (I) is a structural repeat unit of Formula (I-A):

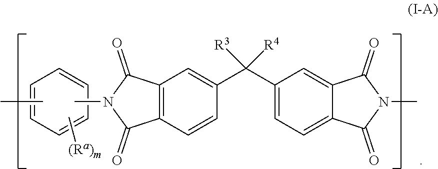

In some embodiments of Formula (I-A), m is 0, 1, 2, 3, or 4. In some embodiments, m is 0. In some embodiments, m is 1. In some embodiments, m is 2. In some embodiments, m is 3. In some embodiments, m is 4. In some embodiments, each R^{a} is the same. In some embodiments, each R^{a} is C₁₋₃ alkyl. In some embodiments, each R^{a} is methyl. In some embodiments, R³ and R⁴ are the same. In some embodiments, R³ and R⁴ are each C₁₋₃ haloalkyl. In some embodiments, R³ and R⁴ are each CF₃.

In some embodiments, the structural repeat unit of Formula (I) is a structural repeat unit of Formula (I-B):

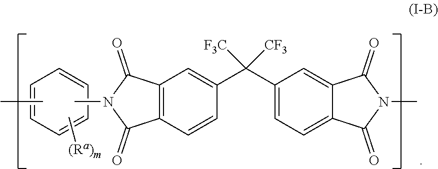

In some embodiments of Formula (I-B), m is 0, 1, 2, 3, or 4. In some embodiments, m is 0. In some embodiments, m is 1. In some embodiments, m is 2. In some embodiments, m is 3. In some embodiments, m is 4. In some embodiments, each R^{a} is the same. In some embodiments, each R^{a} is C₁₋₃ alkyl. In some embodiments, each R^{a} is methyl.

In some embodiments, the structural repeat unit of Formula (I) is a structural repeat unit of Formula (I-C):

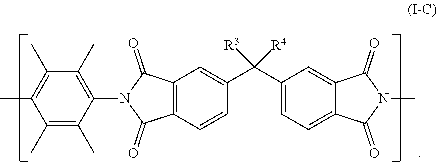

In some embodiments of Formula (I-C), R³ and R⁴ are the same. In some embodiments, R³ and R⁴ are each C₁₋₃ haloalkyl. In some embodiments, R³ and R⁴ are each CF₃.

In some embodiments, the structural repeat unit of Formula (I) is a structural repeat unit of Formula (I-D):

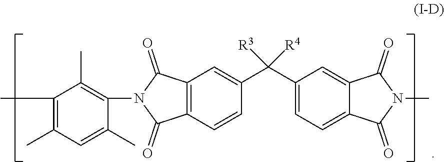

In some embodiments of Formula (I-D), R³ and R⁴ are the same. In some embodiments, R³ and R⁴ are each C₁₋₃ haloalkyl. In some embodiments, R³ and R⁴ are each CF₃.

In some embodiments, the structural repeat unit of Formula (I) is selected from:

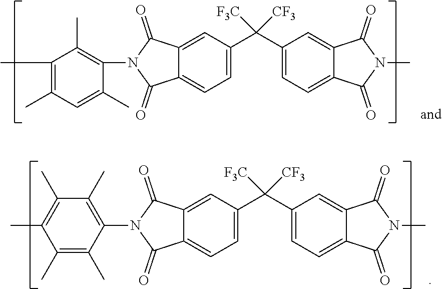

In some embodiments, the structural repeat unit of Formula (I) is:

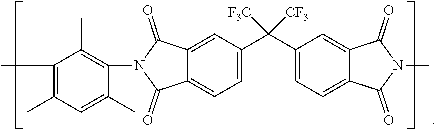

In some embodiments, the structural repeat unit of Formula (I) is:

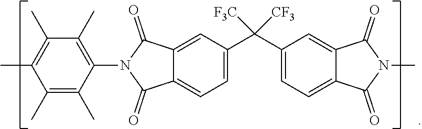

In some embodiments, the structural repeat unit of Formula (II) is a structural repeat unit of Formula (II-A):

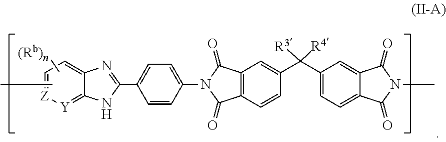

In some embodiments of Formula (II-A), n is 0, 1, 2, 3, or 4. In some embodiments, n is 0.

In some embodiments, n is 1. In some embodiments, n is 2. In some embodiments, n is 3. In some embodiments, n is 4. In some embodiments, Z is N. In some embodiments, Z is CH. In some embodiments, Y is N. In some embodiments, Y is CH. In some embodiments, Y and Z are each CH. In some embodiments, R^{3′} and R^{4′} are the same. In some embodiments, R^{3′} and R^{4′} are each C₁₋₃ haloalkyl. In some embodiments, R^{3′} and R^{4′} are each CF₃.

In some embodiments, the structural repeat unit of Formula (II) is a structural repeat unit of Formula (II-B):

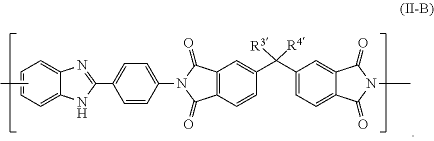

In some embodiments of Formula (II-B), R^{3′} and R^{4′} are the same. In some embodiments, R^{3′} and R^{4′} are each C₁₋₃ haloalkyl. In some embodiments, R^{3′} and R^{4′} are each CF₃.

In some embodiments, the structural repeat unit of Formula (II) is:

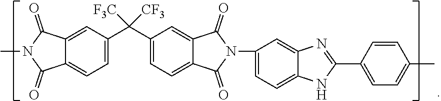

In some embodiments, the polymer of the present disclosure has the formula:

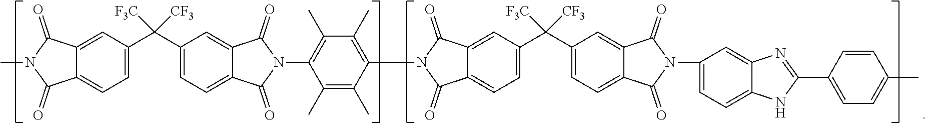

In some embodiments, the polymer of the present disclosure has the formula:

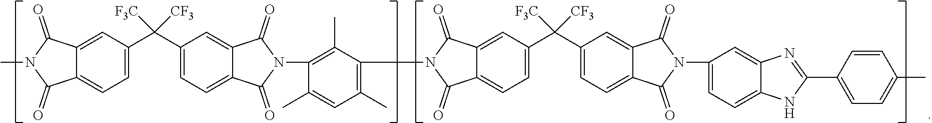

In some embodiments, the structural repeat unit of Formula (I) and the structural repeat unit of Formula (II) make up at least about 80 wt % of the polymer. In some embodiments, the structural repeat unit of Formula (I) and the structural repeat unit of Formula (II) make up at least about 85 wt %, at least about 90 wt %, at least about 95 wt %, at least about 97.5 wt %, at least about 98 wt %, at least about 98.5 wt %, or at least about 99 wt % of the polymer.

In some embodiments, the structural repeat unit of Formula (I) and the structural repeat unit of Formula (II) are present in the polymer in a molar ratio of about 5:1 to about 1:5. In some embodiments, the structural repeat unit of Formula (I) and the structural repeat unit of Formula (II) are present in the polymer in a molar ratio of about 5:1 to about 1:4, about 5:1 to about 1:3, about 5:1 to about 1:2, about 4:1 to about 1:5, about 4:1 to about 1:4, about 4:1 to about 1:3, about 4:1 to about 1:2, about 3:1 to about 1:5, about 3:1 to about 1:4, about 3:1 to about 1:3, about 3:1 to about 1:2, about 2:1 to about 1:5, about 2:1 to about 1:4, about 2:1 to about 1:3, about 2:1 to about 1:2, about 1.5:1 to about 1:5, about 1.5:1 to about 1:4, about 1.5:1 to about 1:3, about 1.5:1 to about 1:2, or about 1:1. In some embodiments, the structural repeat unit of Formula (I) and the structural repeat unit of Formula (II) are present in the polymer in a molar ratio of about 3:1. In some embodiments, the structural repeat unit of Formula (I) and the structural repeat unit of Formula (II) are present in the polymer in a molar ratio of about 2:1. In some embodiments, the structural repeat unit of Formula (I) and the structural repeat unit of Formula (II) are present in the polymer in a molar ratio of about 1.5:1.In some embodiments, the structural repeat unit of Formula (I) and the structural repeat unit of Formula (II) are present in the polymer in a molar ratio of about 1:1.

In some embodiments, the polymer has a number-average molecular weight of about 1,000 g/mol to about 1,000,000 g/mol, such as about 1,000 g/mol to about 900,000 g/mol, about 10,000 g/mol to about 800,000 g/mol, about 50,000 g/mol to about 700,000 g/mol, about 100,000 g/mol to about 600,000 g/mol, about 200,000 g/mol to about 500,000 g/mol, about 300,000 g/mol, or about 1,000 g/mol, about 5,000 g/mol, about 10,000 g/mol, about 25,000 g/mol, about 50,000 g/mol, about 100,000 g/mol, about 150,000 g/mol, about 200,000 g/mol, about 250,000 g/mol, about 300,000 g/mol, about 350,000 g/mol, about 400,000 g/mol, about 450,000 g/mol, about 500,000 g/mol, about 550,000 g/mol, about 600,000 g/mol, about 650,000 g/mol, about 700,000 g/mol, about 750,000 g/mol, about 800,000 g/mol, about 850,000 g/mol, about 900,000 g/mol, about 950,000 g/mol, or about 1,000,000 g/mol.

The polymers of the present disclosure can be prepared according to any suitable method. For example, polymers including a structural repeat unit of Formula (I) can be prepared by polycondensation of a dianhydride monomer and an aromatic imidazole diamine monomer. Polymers including a structural repeat unit of Formula (II) can be prepared by polycondensation of an aromatic diamino monomer and a dianhydride monomer. Polymers including a structural repeat of Formula (I) and Formula (II) can be prepared by polycondensation of an aromatic diamino monomer, a dianhydride monomer, and an aromatic imidazole diamine monomer. In some embodiments, the polymer includes the polymerization product of a diphthalic anhydride monomer (for example, 5,5′-(perfluoropropane-2,2-diyl)bis(isobenzofuran-1,3-dione) (6FDA)), an aromatic imidazole diamine monomer (for example, 5-amino-2-(4-aminophenyl)benzimidazole) (PABZ)), and an aromatic diamino monomer (for example, 2,3,5,6-tetramethylbenzene-1,4-diamine (durene) or 2,4,6-trimethylbenzene-1,3-diamine (DAM)).

The synthetic methodology described in the present disclosure allows for the preparation of a large variety of imidazole-based polymers, including, but not limited to, homopolymers, random copolymers, block copolymers, terpolymers, and alternating copolymers.

### Membranes

Also provided in the present disclosure are membranes including a polymer including a structural repeat unit of Formula (I) and a structural repeat unit of Formula (II). In some embodiments, the membrane includes any polymer of the present disclosure.

In some embodiments, the membrane includes about 99 wt % of the polymer or less. For example, in some embodiments, the membrane includes about 99 wt %, about 95 wt %, about 90 wt %, about 85 wt %, about 80 wt %, about 75 wt %, about 70 wt %, about 65 wt %, about 60 wt %, about 55 wt %, about 50 wt %, about 45 wt %, about 40 wt %, about 35 wt %, about 30 wt %, about 25 wt %, about 20 wt %, or less, of the polymer. In some embodiments, the membrane includes about 99 wt % or less of the polymer.

### Methods for Preparing Membranes

Also provided in the present disclosure are methods for preparing a membrane of the present disclosure. Polymeric membranes are thin semipermeable barriers that selectively separate some gas compounds from others. The membranes are dense films that do not operate as a filter, but rather separate gas compounds based on how well the different compounds dissolve into the membrane and diffuse through it (the solution-diffusion model). The membranes of the present disclosure are useful for any gas separation application, including, but not limited to, natural gas sweetening, oxygen enrichment, hydrogen purification, and nitrogen and organic compounds removal from natural gas. In some embodiments, the membranes of the present disclosure are used for the separation of CO₂ and H₂S from sour gas.

In some embodiments, the method includes preparing a solution of any polymer of the present disclosure. In some embodiments, the polymer is added to a solvent and dissolved. In some embodiments, the solvent is an organic solvent. In some embodiments, the solvent is dimethylformamide (DMF). In some embodiments, the polymer is dissolved at room temperature. In some embodiments, the polymer is dissolved completely in the solvent before proceeding to the next step. In some embodiments, the polymer is filtered. In some embodiments, the polymer is filtered with a PTFE filter.

In some embodiments, the solution contains about 1 wt % to about 10 wt % polymer, such as about 2 wt % to about 5 wt %, or about 3 wt % polymer. In some embodiments, the solution containing the polymer is poured into a flat-bottomed container in order to prepare a film. In some embodiments, the film is dried to allow for evaporation of solvent. In some embodiments, the film is dried at an elevated temperature under a flow of nitrogen gas. In some embodiments, the film is further dried in a vacuum oven, for example, at about 100° C. to about 275° C., or about 150° C. to about 200° C. for at least about 4 hours, about 6 hours, about 12 hours, about 18 hours, about 24 hours, about 30 hours, about 36 hours, about 42 hours, about 48 hours, or more.

In some embodiments, after drying, the film is soaked in a second solvent. In certain such embodiments, the second solvent is deionized water. In some embodiments, the film is soaked in the second solvent for at least a few minutes or more. In some embodiments, the second solvent is removed from the film, and then the film is dried to provide the membrane. In some embodiments, the second solvent is removed from the film, and then the film is dried in a vacuum oven, for example, at about 60° C. for about 6 hours.

Also provided in the present disclosure are membranes prepared by the methods of the present disclosure. In general, for natural gas purification, it is desired to improve the permeability of impurities (such as carbon dioxide (CO₂) and hydrogen sulfide (H₂S)) and the membrane selectivities (CO₂/CH₄ and H₂S/CH₄) toward the main hydrocarbons constituting the natural gas (methane (CH₄)). In another aspect, it is desired to increase the plasticization resistance of polymeric membranes during high pressure mixed-gas separation. In some embodiments, the polar amine groups of the imidazole groups form a hydrogen bond or dipole-dipole type interaction between the polymeric chains which limits their mobility under harsh separation conditions of temperature and pressure. This strategy has proven to improve the permeation properties and plasticization resistance of the polymeric membranes during mixed-gas separation at high feed pressures.

In some embodiments, the membranes of the present disclosure demonstrate improved gas transport properties in natural gas separation, for example, sour gas separation, as compared to conventional polymer-based membranes that do not contain an imidazole-based moiety. In some embodiments, the membranes of the present disclosure demonstrate high CO₂/CH₄ selectivity, high H₂S/CH₄ selectivity, and resistance to plasticization, for example, at a feed pressure up to about 900 psi, as compared to conventional polyimide-based membranes that do not contain an imidazole-based moiety. The membranes of the present disclosure possess increased CO₂ permeation coefficients and comparable CO₂/CH₄ selectivity as compared to convention polyimide-based membranes that do not contain an imidazole-based moiety.

### Methods of Using the Membranes

Natural gas purification technology involves the use of liquid amines to remove acid gases from natural gas reserves. The use of liquid amines includes a liquid amine regeneration step which requires the consumption of a substantial amount of energy; a step that renders the process costly. The gas separation membranes of the present disclosure provide an alternative energy efficient method. The membranes of the present disclosure possess a set of specifications related to their gas permeability (or permeance) (H₂S and CO₂) and selectivity (CO₂/CH₄ and H₂S/CH₄) that allow this technology to compete with or be conjugated with current technology. Current commercial membranes exhibit mixed sour gas selectivity for CO₂/CH₄ and H₂S/CH₄ from 15 up to 25 and permeance up to 80 GPU for CO₂ and H₂S. Thus, the membranes of the present disclosure, with high CO₂ and H₂S permeability can be used in a bulk acid gas removal process. In some embodiments, the imidazole-based polyimides provide for an improved membrane system for sweet and sour mixed-gas separation.

Thus, also provided in the present disclosure are methods for using a membrane of the present disclosure. In some embodiments, the methods include separating CO₂, H₂S, or both from natural gas by introducing a natural gas stream to any membrane of the present disclosure, and separating the CO₂, H₂S, or both from the natural gas stream. In some embodiments, the natural gas stream includes about 1 vol % to about 30 vol % of CO₂ before separating. For example, in some embodiments, the natural gas stream includes about 1 vol % to about 20 vol %, about 1 vol % to about 15 vol %, about 3 vol % to about 30 vol %, about 3 vol % to about 20 vol %, or about 3 vol % to about 15 vol % of CO₂ before separating. In some embodiments, the natural gas stream includes about 1 vol % to about 40 vol % of H₂S before separating. For example, in some embodiments, the natural gas stream includes about 1 vol % to about 30 vol %, about 1 vol % to about 25 vol %, about vol % to about 40 vol %, about 5 vol % to about 30 vol %, or about 5 vol % to about 25 vol % of H₂S before separating.

In some embodiments, the natural gas stream includes at least about 30 vol %, for example, at least about 40 vol %, or at least about 50 vol % of CH₄ before separating. In some embodiments, the natural gas stream further includes N₂, C₂H₆, or both.

### Examples

### Example 1—Preparation of 6FDA-PABZ Homopolymer

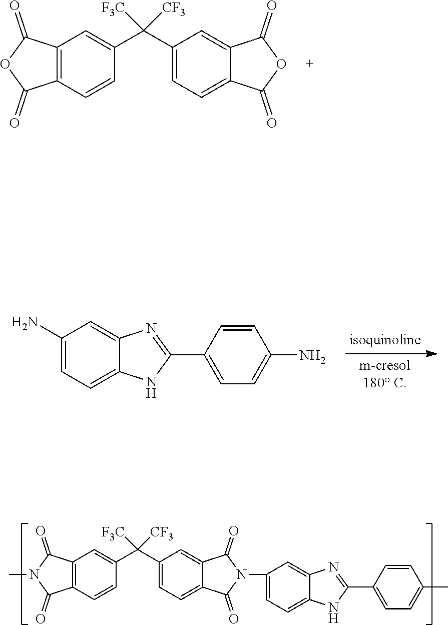

In a 100-mL three-neck round bottom flask equipped with a nitrogen inlet and a magnetic bar, 5,5′-(perfluoropropane-2,2-diyl)bis(isobenzofuran-1,3-dione) (1.981 g, 4.46 mmol) (6FDA) and 5-amino-2-(4-aminophenyl)benzimidazole (1.000 g, 4.46 mmol) (PABZ) were introduced and dissolved in m-cresol (15.00 mL). The reaction mixture was heated to 150° C. and stirred for 6 hours. The heat was then gradually increased to 180° C. for 2 hours. The heat was removed, and the reaction mixture was allowed to cool down below 100° C. The resulting highly viscous solution was poured into methanol in thin fibers. The fibrous polymer obtained was ground, rinsed with methanol, filtered, and dried under reduced pressure for 24 h at 60° C. to afford 6FDA-PABZ (2.90 g, 4.37 mmol, 98% yield) as an off-white powder. ¹H NMR (500 MHz, DMSO-d₆) δ 13.07 (s, 1H), 8.37-7.58 (m, 12H), 7.29 (dd, J=22.7, 8.5 Hz, 1H).

### Example 2—Preparation of 6FDA-Durene/PABZ (1:1) Block Copolyimide

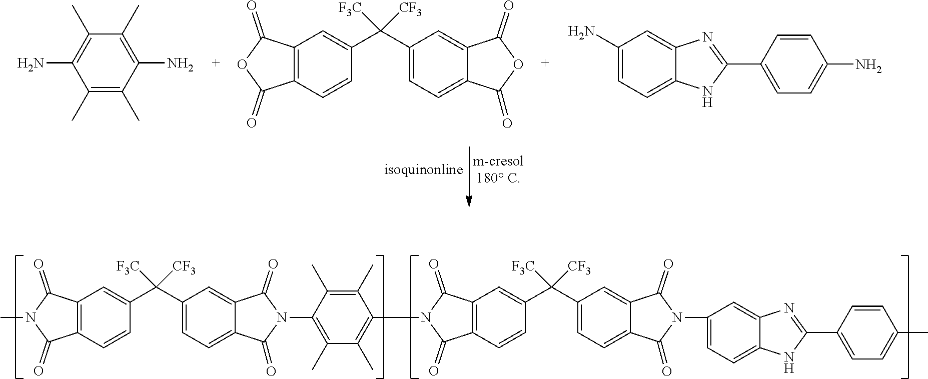

In a 100-mL three-neck round bottom flask equipped with a nitrogen inlet and a magnetic bar, 5,5′-(perfluoropropane-2,2-diyl)bis(isobenzofuran-1,3-dione) (0.811 g, 1.827 mmol) (6FDA) and 2,3,5,6-tetramethylbenzene-1,4-diamine (0.300 g, 1.827 mmol) (durene) were introduced and dissolved in m-cresol (9.00 mL). The reaction mixture was heated to 85° C. and stirred for 24 h. 6FDA (0.812 g, 1.827 mmol) (6FDA) and 5-amino-2-(4-aminophenyl)benzimidazole (0.410 g, 1.827 mmol) (PABZ) were then added, followed by m-cresol (9.00 mL) and 10 drops of isoquinoline. The heat was then gradually increased to 150° C. and then to 180° C. for 4 hours each. The heat was removed, and the reaction mixture was allowed to cool down below 100° C. The resulting highly viscous solution was poured into methanol in thin fibers. The fibrous polymer obtained was ground, rinsed with methanol, filtered and dried under reduced pressure for 24 h at 60° C. to afford 6FDA-durene/PABZ (1:1) (2.211 g, 1.790 mmol, 98% yield) as an off-white powder. ¹H NMR (500 MHz, DMSO-d₆) δ 13.00 (s, 1H), 8.40-7.26 (m, 19H), 2.10 (s, 12H).

### Example 3—Preparation of 6FDA-Durene/PABZ (2:3) Block Copolyimide

The same procedure as described in Example 2 was followed, using 6FDA (0.811 g, 1.827 mmol), durene (0.300 g, 1.827 mmol), and m-cresol (9.00 mL), then, 6FDA (1.217 g, 2.74 mmol), PABZ (0.615 g, 2.74 mmol), m-cresol (13.5 mL), and 10 drops of isoquinoline to afford 6FDA-durene/PABZ (2:3) (2.73 g, 1.790 mmol, 98% yield) as an off-white powder. ¹H NMR (500 MHz, DMSO-d₆) δ 13.05 (s, 2H), 8.49-7.44 (m, 33H), 7.33-7.19 (m, 2H), 2.05 (s, 18H).

### Example 4—Preparation of 6FDA-Durene/PABZ (3:1) Block Copolyimide

The same procedure as described in Example 2 was followed, using 6FDA (2.298 g, 5.17 mmol), durene (1.000 g, 6.09 mmol), and m-cresol (15.00 mL), then 6FDA (1.307 g, 2.94 mmol), PABZ (0.455 g, 2.028 mmol), m-cresol (5.00 mL) and 10 drops of isoquinoline to afford 6FDA-durene/PABZ (3:1) (4.67 g, 1.988 mmol, 98% yield) as an off-white powder. ¹H NMR (500 MHz, DMSO-d₆) δ 13.08 (s, 1H), 8.54-7.05 (m, 31H), 2.09 (s, 36H).

### Example 5—Preparation of 6FDA-DAM/PABZ (3:1) block copolyimide

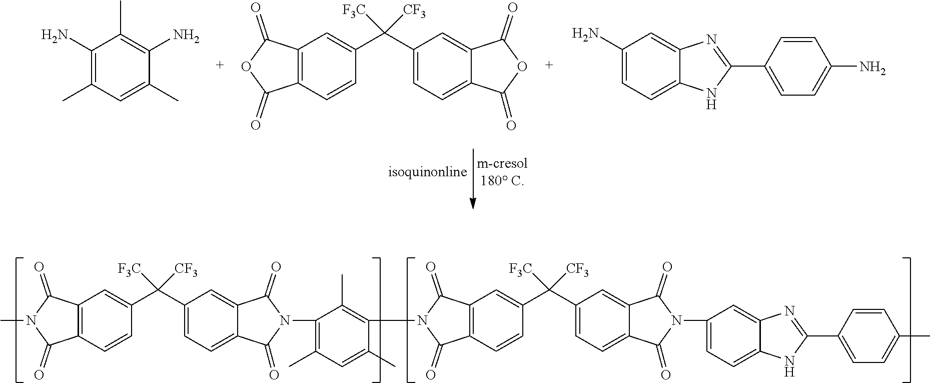

In a 100-mL three-neck round bottom flask equipped with a nitrogen inlet and a magnetic bar, 6FDA (2.51 g, 5.66 mmol) and 2,4,6-trimethylbenzene-1,3-diamine (1.000 g, 6.66 mmol) (DAM) were introduced and dissolved in m-cresol (15.00 mL). The reaction mixture was heated to 85° C. and stirred for 24 h. Then 6FDA (1.429 g, 3.22 mmol) and PABZ (0.497 g, 2.218 mmol) were added to the flask, followed by m-cresol (5.00 mL) and 10 drops of isoquinoline. The heat was then gradually increased to 150° C. and then 180° C. for 4 hours each. The heat was removed, and the reaction mixture was allowed to cool down below 100° C. The resulting highly viscous solution was poured into methanol in thin fibers. The fibrous polymer obtained was ground, rinsed with methanol, filtered, and dried under reduced pressure for 24 h at 60° C. to afford 6FDA-DAM/PABZ (3:1) (5.02 g, 2.173 mmol, 98% yield) as an off-white powder. ¹H NMR (500 MHz, DMSO-d₆) δ 13.07 (s, 1H), 8.36-7.67 (m, 30H), 7.32 (s, 4H), 2.15 (s, 18H), 1.92 (s, 9H).

### Example 6—Preparation of 6FDA-DAM/PABZ (2:1) block copolyimide

The same procedure as described in Example 5 was followed, using 6FDA (1.884 g, 4.24 mmol), DAM (0.750 g, 4.99 mmol), and m-cresol (11.50 mL), then 6FDA (1.441 g, 3.24 mmol), PABZ (0.560 g, 2.495 mmol), m-cresol (5.00 mL), and 10 drops of isoquinoline, to afford 6FDA-DAM/PABZ (2:1) (4.28 g, 2.445 mmol, 98% yield) as an off-white powder. ¹H NMR (500 MHz, DMSO-d₆) δ 13.08 (s, 1H), 8.37-8.12 (m, 8H), 8.02-7.58 (m, 16H), 7.32 (s, 3H), 2.15 (s, 12H), 1.92 (s, 6H).

### Example 7—Chemical characterization

The chemical structures and purity of the final product of the polymers described in Examples 1-6 were confirmed using ¹H-NMR in DMSO-d₆.

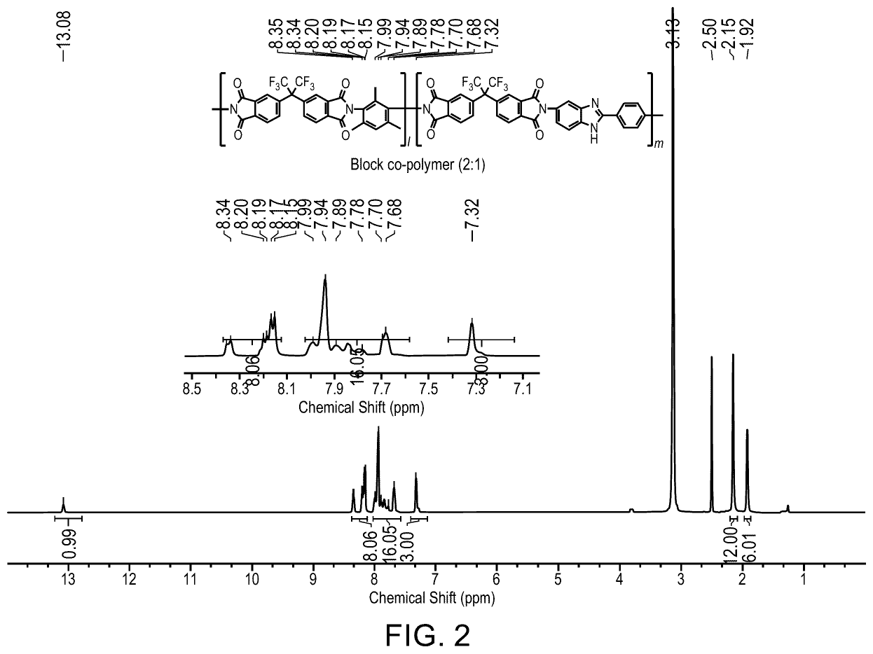

For copolyimides, in addition to determining their chemical structures and purities, the ¹H NMR spectra were further used to determine the molecular ratio of the comonomers within the copolymer backbone. For example, the desired molar ratio between the comonomers DAM and PABZ in the 6FDA-DAM/PABZ (2:1) block copolymer described in Example 6 was calculated from the area integration of the aromatic peaks of PABZ and aliphatic peaks of DAM, from the spectrum illustrated in FIG. 2.

For example, the DAM monomer possesses one aromatic proton that showed up as a singlet at 7.32 ppm, and nine aliphatic protons, which appeared as two singlets at 1.92 ppm and 2.15 ppm, that correspond to its three methyl groups. As per the spectrum illustrated in FIG. 2, the aromatic peak of DAM overlapped with one of the aromatic peaks of PABZ at 7.32 ppm. The total integration was set to 3 protons (2 DAM units and 1 PABZ unit), and the signals integration of the aliphatic methyl groups of DAM was equal to 6 protons (2×3 protons, at 1.92 ppm) and 12 protons (2×6 protons, at 2.15 ppm). The remaining aromatic protons were equal to 24 protons (18 protons for 6FDA units, and 6 protons of PABZ unit). Moreover, the peak corresponding to the 1 proton of the secondary amine (—NH—) group appeared as a singlet at 13.08 ppm. The analysis of the ¹H-NMR spectrum of the 6FDA-DAM/PABZ (2:1) block copolymer indicated a molar ratio of 2:1 between DAM and PABZ co-monomers. The absence of any undesired peaks within the spectrum was an indication of the high purity of the prepared polymer.

In a similar way, the molar ratios between the durene and PABZ comonomers in 6FDA-durene/PABZ (1:1), 6FDA-durene/PABZ (2:3), and 6FDA-durene/PABZ (3:1) block copolymers (described in Examples 2, 3, and 4, respectively), and DAM and PABZ in 6FDA-DAM/PABZ (3:1) block copolymer (described in Example 5) were determined using their corresponding ¹H NMR spectra.

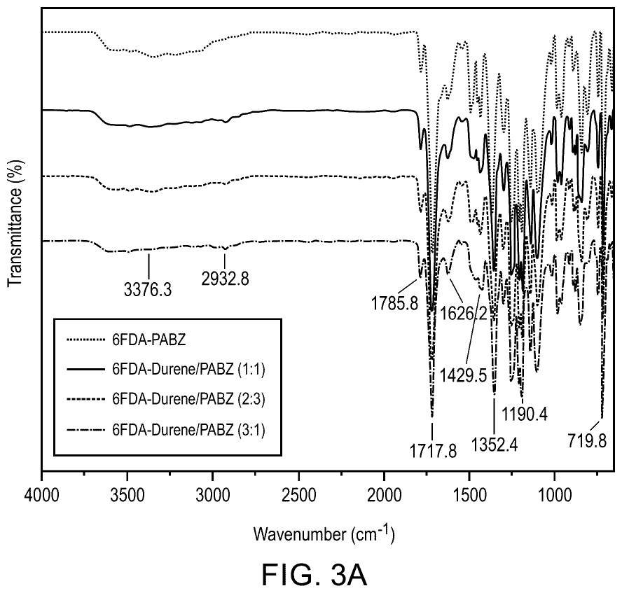

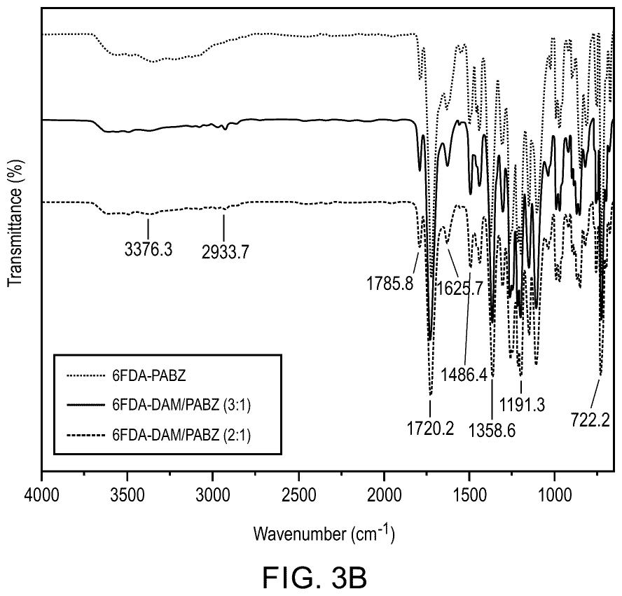

The FTIR spectra of all of the polymers described in Examples 1-6 were recorded to ensure that the polycondensation reaction was completed (see FIGS. 3A-3B). In general, the absence of any peaks that corresponded to the intermediate species polyamic acid (3500-3100 and 1700-1650 cm⁻¹) demonstrated that the reaction was completed. The symmetric and asymmetric carbonyl groups of the imide ring depicted at 1785 cm⁻¹ and 1718 cm⁻¹, respectively, confirmed the formation of the imide ring (final product) within the polymer backbone, in addition to the imide ring deformation band that appeared at 720 cm¹. The secondary amine (—NH—) group was distinguished by the broad band at 3376 cm⁻¹. This peak was most prominent in the homopolyimide 6FDA-PABZ and became relatively less intense in the case of copolyimides. Finally, the appearance of the peaks at around 2933 cm⁻¹ in the FTIR spectra of the five copolyimides described in Examples 2-6 in FIG. 3A (6FDA-durene/PABZ (x:y)) and FIG. 3B (6FDA-DAM/PABZ (x:1)) are attributed to the aliphatic C—H bonds of the methyl groups in durene (FIG. 3A) and DAM (FIG. 3B).

### Example 8—Thermal and Physical Properties

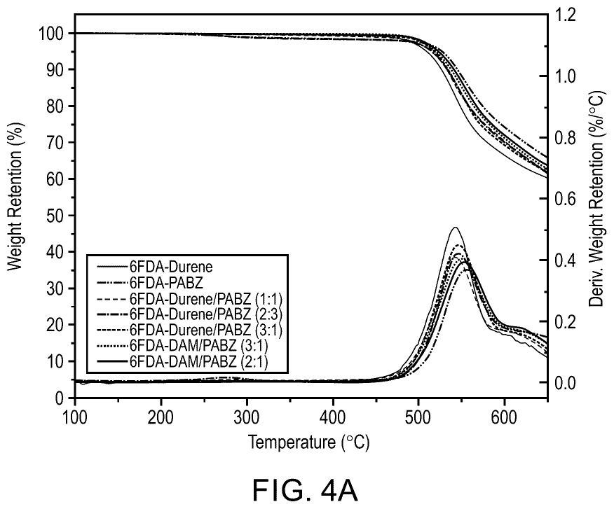

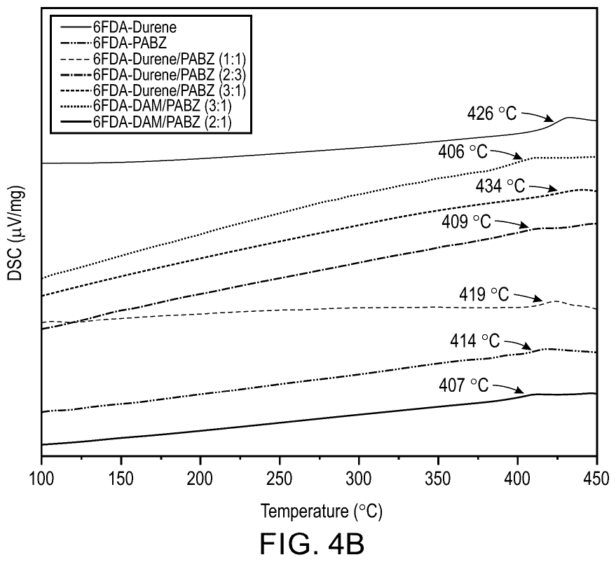

The thermal properties of the polymers prepared as described in Examples 1-6 were measured using thermal gravimetric analysis (TGA) and differential scanning calorimetry (DSC) and the results are illustrated in FIGS. 4A-4B. The decomposition temperatures at 5% and 10% were determined to evaluate the thermal stability of the prepared polymers during the harsh industrial conditions of gas separation application (Table 1). All T_{d5%} of the prepared copolymers were recorded to be higher than 510° C. which is similar to high thermally stable membranes used in gas separation technology. The first derivatives of the TGA curves (FIG. 4A) were calculated and the values are listed in Table 1. These values (>540° C.) indicate the highest temperature at which the polymer degrades the fastest and are additional indication to the high thermal stability of the prepared polymers.

TABLE 1
Thermal properties of the polymers

| | DSC | TGA | | |
|---|---|---|---|---|
| | T_{g} (° C.) | T_{d5%} (° C.) | T_{d10%} (° C.) | DTG (° C.) |
| 6FDA-durene | 426 | 510 | 527 | 542 |
| 6FDA-DAM | 395 | 516 | 530 | 545 |
| 6FDA-PABZ | 414 | 526 | 544 | 556 |
| 6FDA-durene/PABZ (1:1) | 419 | 515 | 532 | 543 |
| 6FDA-durene/PABZ (2:3) | 409 | 516 | 534 | 546 |
| 6FDA-durene/PABZ (3:1) | 434 | 518 | 535 | 545 |
| 6FDA-DAM/PABZ (3:1) | 406 | 521 | 538 | 551 |
| 6FDA-DAM/PABZ (2:1) | 407 | 524 | 541 | 554 |

The glass transition temperatures (T_{g}) of the polymers described in Examples 1-6 were calculated from their corresponding DSC traces and the values are listed in Table 1. To obtain the T_{g} values, polymer samples were heated for two cycles. The first heating cycle was used to clear the thermal history of the polymer, where the T_{g} was recorded after the second heating cycle. All the recorded T_{g} values were greater than 406° C. These high temperatures indicate the rigidity of the polymeric chains, which can be correlated to their performance during gas separation testing. The values obtained were similar to other glassy polymers used in gas separation technology.

### Example 9—Membrane Preparation

Dense polymeric films of ˜80-100 μm thickness were prepared by casting 3 wt. % solutions of the polymers prepared according to Examples 1-6 in dimethylformamide (DMF) onto flat glass Petri dishes. The solutions were first filtered using 0.45 μm PTFE filters to remove undissolved polymer material or impurities. The casted solutions were placed on a leveled surface in an oven preheated to 90° C. under a gentle nitrogen flow for slow solvent evaporation. The membranes obtained were then placed in an oven heated at 200° C. under vacuum. When needed, to peel off the membranes from the Petri dishes, the membrane samples were soaked in deionized water for a few minutes and then dried at 60° C. in a vacuum oven for 6 h to remove water.

### Example 10—Pure-Gas Permeation Measurements

In general, a separation membrane can be evaluated by its two intrinsic key characteristics: permeability (P) and selectivity (a). The permeability defines the productivity of the membrane, while the selectivity represents its efficiency. Experimentally, the permeability of a single gas stream through nonporous membranes can be determined using a constant-volume/variable-pressure system using the following expression:

$$P = 1 {0}^{10} \frac{{V}_{d} l}{{p}_{f} ART} [ {( \frac{{dp}_{p}}{dt} )}_{ss} - {( \frac{{dp}_{p}}{dt} )}_{leak} ]$$

where V_{d} is the permeate tube volume (cm³), l is the membrane thickness (cm), p_{f} is the gas feed pressure (cmHg), A is the membrane effective surface area (cm²), R is the universal gas constant (R=0.278 cm³·cmHg-cm⁻³(STP)·K⁻¹), T is the operational temperature (K),

$${( \frac{{dp}_{p}}{dt} )}_{ss}$$

is the steady-state (ss) pressure variation in the permeate side (cmHg), and

$${( \frac{{dp}_{p}}{dt} )}_{leak}$$

is the leak rate of the system, which in most cases is very small and thus could be neglected. The permeability unit used is Barrer, where 1 Barrer=10⁻¹⁰ cm³(STP)·cm·cm⁻²·s⁻¹·cmHg⁻¹.

The ideal selectivity (a) of the membrane for separating two distinguished gases A and B can be determined through their single gas permeability coefficients (P_{A} and P_{B}) using the following equation:

$${α}_{A / B} = \frac{{P}_{A}}{{P}_{B}}$$

The permeability coefficient is governed by two main stages of the gas permeation process: sorption and diffusion. The sorption of a gas penetrant into the membrane, which is a thermodynamic process, depends mainly on the gas properties (condensability and gas-polymer affinity), however, the diffusion, which is a kinetic process, depends on the gas particle size (kinetic diameter). The smaller the kinetic diameter, the higher the diffusion rate. Therefore, the permeability can be defined using the following expression:

$$P = D \times S$$

where D is the diffusivity coefficient (cm²/s), and S is the solubility coefficient (cm³(STP) ·cm⁻³·cmHg⁻¹). Using this equation, the ideal selectivity expression could be modified using the solubility and diffusivity coefficients by:

$${α}_{A / B} = \frac{{P}_{A}}{{P}_{B}} = ( \frac{{D}_{A}}{{D}_{B}} ) \times ( \frac{{S}_{A}}{{S}_{B}} )$$

The diffusivity coefficient can be experimentally determined using the time-lag method through the following expression:

$$D = \frac{{l}^{2}}{6 θ}$$

where l is the membrane thickness (cm) and θ is the time-lag (s). The solubility coefficient can thereafter be deduced from the permeability equation:

$$S = \frac{P}{D}$$

The pure-gas permeation properties of membranes prepared from the polymers described in Examples 1-6 and membranes containing 6FDA-durene and 6FDA-DAM homopolymers were determined using a constant-volume permeation system. Four different single gases were used: He, N₂, CH₄ and CO₂. The permeability coefficients of the polymeric membranes were calculated from the steady state of the pressure versus time curve, using a constant feed pressure of 100 psi and an operating temperature of 22° C. The permeability coefficients are expressed in Barrer [1 Barrer=10⁻¹⁰ cm³(STP)·cm/(cm²·s·cmHg)]. The ideal selectivity coefficients were calculated by dividing the permeability coefficient of a corresponding gas (i.e., He, N₂, or CO₂) by that of methane. The results are listed in Table 2.

TABLE 2
Pure gas permeability and selectivity coefficients for the polymeric
membranes measured at 100 psi feed pressure and at 22° C.

| | Permeability coefficients | | | | | | |
|---|---|---|---|---|---|---|---|
| | (Barrer) | | | | Selectivity coefficients | | |
| Polyimide | He | N₂ | CH₄ | CO₂ | He/CH₄ | N₂/CH₄ | CO₂/CH₄ |
| 6FDA-durene | 451 | 55.9 | 46.1 | 740 | 9.77 | 1.21 | 16.0 |
| 6FDA-DAM | 332 | 35.0 | 24.3 | 541 | 13.7 | 1.44 | 22.3 |
| 6FDA-PABZ | 41.3 | 0.501 | 0.302 | 13.3 | 137 | 1.66 | 44.2 |
| 6FDA-durene/PABZ (1:1) | 170 | 8.07 | 4.80 | 133 | 35.5 | 1.68 | 27.8 |
| 6FDA-durene/PABZ (2:3) | 110 | 3.29 | 1.82 | 70.0 | 60.4 | 1.80 | 38.4 |
| 6FDA-durene/PABZ (3:1) | 339 | 29.6 | 20.4 | 404 | 16.6 | 1.45 | 19.8 |
| 6FDA-DAM/PABZ (3:1) | 248 | 16.3 | 10.7 | 260 | 23.2 | 1.53 | 24.4 |
| 6FDA-DAM/PABZ (2:1) | 235 | 11.3 | 7.57 | 211 | 31.1 | 1.49 | 27.9 |

The pure-gas permeation properties of the 6FDA-PABZ homopolyimide demonstrate that this homopolymer can be used as a selectivity enhancing segment in copolyimides, since the ideal CO₂/CH₄ selectivity is measured as 44.2. However, since the CO₂ pure-gas permeability is considered low (13.3 Barrer) for this polymer to be used in industrial applications, it becomes necessary to copolymerize this homopolymer with another permeability-enhancing segment, such as 6FDA-durene or 6FDA-DAM.

In several of the polymeric materials, the durene moiety was replaced by a DAM moiety, with a DAM:PABZ molar ratio equal to 3:1 and 2:1 to form the 6FDA-DAM/PABZ (3:1) and 6FDA-DAM/PABZ (2:1) block copolyimides, respectively. The 6FDA-DAM/PABZ (3:1) polymer afforded a membrane with ˜23% higher CO₂/CH₄ selectivity coefficient than its equivalent 6FDA-durene/PABZ (3:1) polymer with ˜36% lower permeability coefficient.

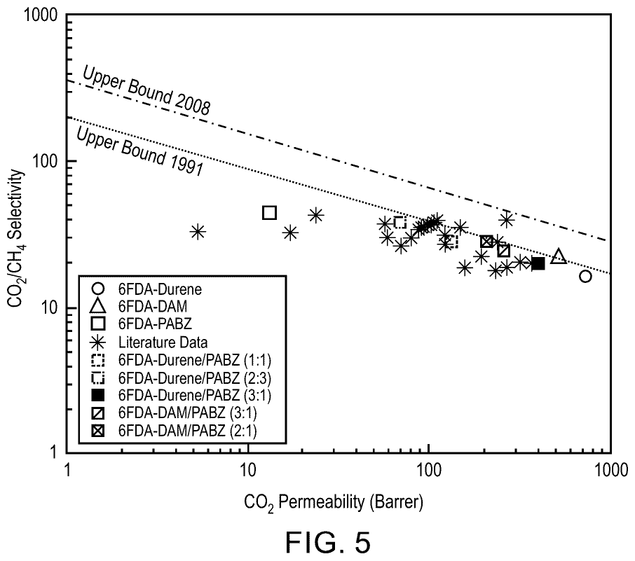

In general, membranes prepared from glassy polymers suffer from a permeability-selectivity trade-off relationship (FIG. 5). For example, the CO₂/CH₄ selectivity decreased from 24.4 for 6FDA-DAM/PABZ (3:1) to 19.8 for 6FDA-durene/PABZ (3:1), while the CO₂ permeability increased from 260 Barrer to 404 Barrer, respectively. However, the gas permeation properties of the imidazole-containing polymeric membranes afforded permeability and selectivity coefficients in the desired potentially commercially favored range.

To better understand the separation process through the prepared membranes, the CO₂ and CH₄ diffusivity coefficients (in cm²/s) were measured using the “time-lag” method. The obtained results are listed in Table 3.

TABLE 3
CO₂ and CH₄ diffusivity coefficients of
prepared polymers at 100 psi and 22° C.

| | Diffusivity | | Diffusivity |
|---|---|---|---|
| | (cm²/s) × 10⁻⁸ | | Selectivity |
| Polymer | CH₄ | CO₂ | CO₂/CH₄ |
| 6FDA-durene | 7.24 | 33.3 | 4.60 |
| 6FDA-DAM | 4.98 | 25.3 | 5.08 |
| 6FDA-PABZ | 0.174 | 1.19 | 6.84 |
| 6FDA-durene/PABZ (1:1) | 0.906 | 5.75 | 6.35 |
| 6FDA-durene/PABZ (2:3) | 0.548 | 3.36 | 6.13 |
| 6FDA-durene/PABZ (3:1) | 3.16 | 17.8 | 5.63 |
| 6FDA-DAM/PABZ (3:1) | 1.67 | 11.4 | 6.83 |
| 6FDA-DAM/PABZ (2:1) | 2.05 | 10.8 | 5.27 |

The diffusivity coefficients for both CO₂ and CH₄ for the series of durene:PABZ copolyimides showed to increase with a higher durene molar ratio within the copolymer backbones.

Since the permeability coefficient (P) is calculated from the product of diffusivity (D) and solubility (S) coefficients, the solubility coefficients of the prepared polymers were calculated using the following equation:

$$S = \frac{P}{D}$$

The obtained solubility coefficients [in cm³(STP)/(cm³.cmHg)]are listed in Table 4.

TABLE 4
CO₂ and CH₄ solubility coefficients of
prepared polymers at 100 psi and 22° C.

| | Solubility | | |
|---|---|---|---|
| | [cm³(STP)/ | | Solubility |
| | (cm³cmHg)] × 10⁻² | | Selectivity |
| Polymer | CH₄ | CO₂ | CO₂/CH₄ |
| 6FDA-durene | 6.24 | 22.1 | 3.54 |
| 6FDA-DAM | 4.48 | 20.7 | 4.62 |
| 6FDA-PABZ | 1.73 | 11.1 | 6.42 |
| 6FDA-durene/PABZ (1:1) | 5.03 | 23.1 | 4.59 |
| 6FDA-durene/PABZ (2:3) | 3.32 | 20.7 | 6.23 |
| 6FDA-durene/PABZ (3:1) | 6.40 | 22.7 | 3.55 |
| 6FDA-DAM/PABZ (3:1) | 6.41 | 22.8 | 3.56 |
| 6FDA-DAM/PABZ (2:1) | 3.70 | 19.6 | 5.30 |

The CO₂/CH₄ diffusivity and solubility selectivity coefficients were calculated and the results are listed in Tables 3 and 4, respectively. The CO₂/CH₄ diffusivity selectivity coefficients of the durene:PABZ copolyimides were in the range of 5.63-6.35, while the CO₂/CH₄ solubility selectivity coefficients were between 3.55-6.23, indicating that the separation through these polymeric membranes was equally solubility and diffusivity driven.

Similarly, The CO₂/CH₄ diffusivity selectivity coefficients of DAM/PABZ copolyimides were 6.83 for a 3:1 molar ratio and 7.20 for a 2:1 molar ratio, while the CO₂/CH₄ solubility selectivity coefficients were found to be ˜3.40, indicating that the separation through these polymeric membranes was diffusivity driven.

### Example 11—Sweet Mixed-Gas Permeation Measurements

Since natural gas is a mixture of gases, it is important to study the mixed-gas separation performance of polymeric membranes. For a gas mixture, the determination of the permeability coefficients of individual gases is determined using a constant-pressure/variable-volume permeation system. The system allows the determination of the permeate gas composition, a set of data needed to determine the permeability coefficient of a particular gas A using the following expression:

$${P}_{A} = {P}_{total} \frac{{y}_{A} ( {p}_{p} - {p}_{f} )}{{x}_{A} {p}_{p} - {y}_{A} {p}_{f}}$$

where Pₜₒₜₐₗ is the permeability of total gas particles permeated through the membrane, x_{A} and y_{A}are the mole fractions of gas A in the feed and the permeate sides, respectively, and are determined experimentally using a gas chromatography analyzer connected to the system. The terms pₚ and p_{f} are the partial pressures of gas A in the feed and the permeate sides, respectively.

Pₜₒₜₐₗ can be determined using the following expression:

$${P}_{total} = \frac{Jl}{Δ p}$$

where J is the penetrant flux (cm³(STP)·cm⁻²·s⁻¹), l is the membrane thickness (cm) and Δp is the difference between the partial pressures of gas A at the feed and the permeate sides (cmHg).

The selectivity coefficient (α*_{AB}) which is the ability of a polymeric membrane to separate a binary feed gas mixture, is defined as follows:

$${α}_{A / B}^{*} = ( \frac{{y}_{A}}{{y}_{B}} ) \times ( \frac{{x}_{B}}{{x}_{A}} )$$

where y_{A} and y_{B} are the mole fractions of gases A and B at the permeate side, and x_{A} and x_{B} are the mole fractions of gases A and B at the feed side.

To reflect the real properties of the membrane in the case of a non-ideal gas mixture, the modified expression of the selectivity

$$( {α}_{AB}^{m , *} )$$

is expressed by

$${α}_{A / B}^{m , *} = \frac{{P}_{A}^{*}}{{P}_{B}^{*}}$$

where P_{A}* and P_{B}* are the mixed-gas permeability coefficients of components A and B.

### Example 12—Gas Feed Pressure Study

Since natural gas is a mixture ofdifferent gases, the mixed-gas separation performance of the polymeric membranes was determined. For that, the mixed-gas separation performance of the polymers described in Examples 1-6 were measured using a sweet gas mixture containing 28, 62, and 10 mol. % of CO₂, CH₄, and N₂, respectively. The permeation measurements were recorded at different feed pressures (300-900 psi) with an increment of 200 psi at a fixed temperature of 22° C. The obtained results are listed in Table 5.

TABLE 5
Sweet mixed-gas permeability and selectivity coefficients of
durene:PABZ copolymers at various feed pressures and 22° C.

| | | Permeability coefficients | | | Selectivity | |
|---|---|---|---|---|---|---|
| | P | (Barrer) | | | coefficients | |
| Polymer | (psi) | N₂ | CH₄ | CO₂ | N₂/CH₄ | CO₂/CH₄ |
| 6FDA-durene/PABZ (1:1) | 500 | 0.616 | 0.780 | 32.7 | 0.790 | 41.9 |
| | 700 | 0.993 | 1.14 | 48.2 | 0.869 | 42.2 |
| | 900 | 1.22 | 1.28 | 53.4 | 0.956 | 41.8 |
| 6FDA-durene/PABZ (2:3) | 300 | 0.722 | 0.859 | 43.7 | 0.841 | 50.9 |
| | 500 | 0.828 | 0.96 | 48.1 | 0.863 | 50.1 |
| | 700 | 1.00 | 1.02 | 49.5 | 0.980 | 48.4 |
| | 900 | 1.05 | 1.09 | 50.1 | 0.965 | 46.1 |
| 6FDA-durene/PABZ (3:1) | 300 | 6.83 | 7.29 | 233 | 0.938 | 32.0 |
| | 500 | 6.95 | 7.18 | 216 | 0.969 | 30.1 |
| | 700 | 6.50 | 7.53 | 207 | 0.864 | 27.5 |
| | 900 | 6.82 | 8.21 | 206 | 0.830 | 25.1 |

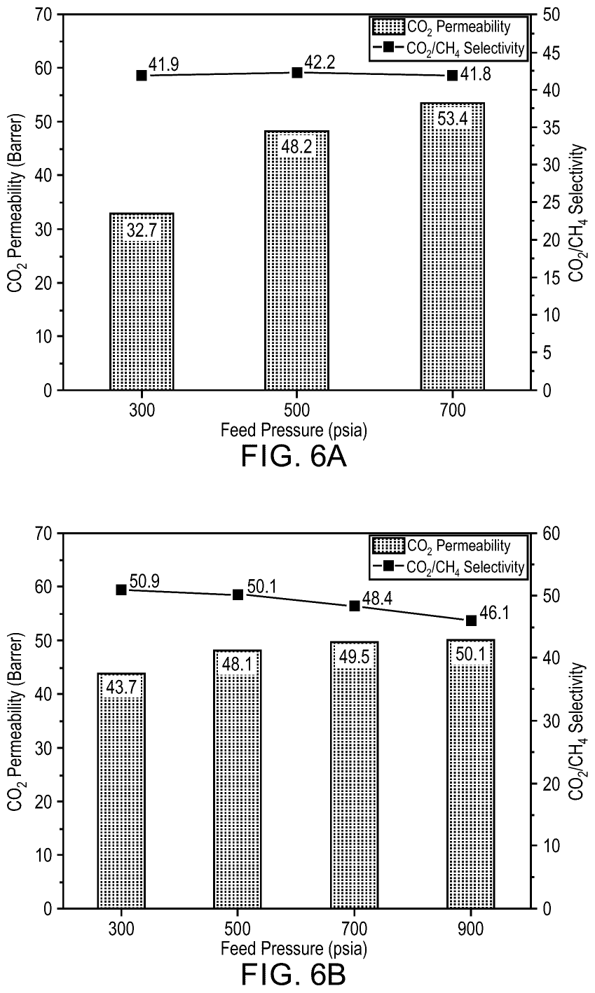

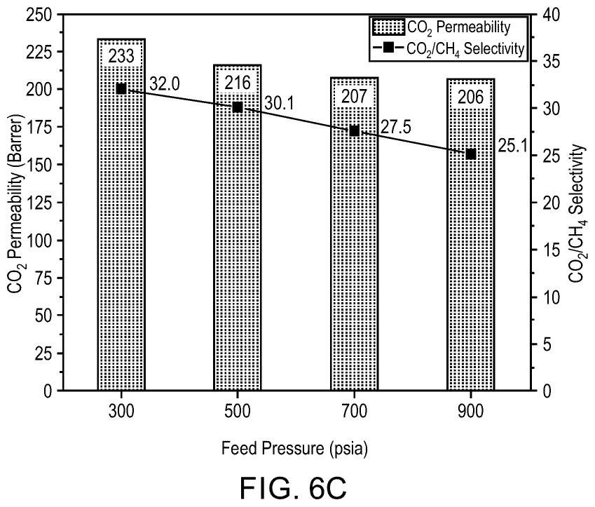

For the durene:PABZ copolyimides series, the mixed-gas CO₂-permeability coefficients along with their corresponding mixed-gas CO₂/CH₄ selectivity coefficients at the various feed pressures are illustrated in FIGS. 6A-6C for 6FDA-durene/PABZ (1:1) (FIG. 6A), 6FDA-durene/PABZ (2:3) (FIG. 6B), and 6FDA-durene/PABZ (3:1) (FIG. 6C). It was observed that the CO₂ permeability coefficients tended to decrease with the increase in the feed pressure (from 300 to 900 psi). For example, the mixed-gas CO₂ permeability coefficient of 6FDA-durene/PABZ (3:1) decreased by ˜12% when the feed pressure increased from 300 psi to 900 psi. This change on mixed-gas CO₂ permeability coefficients is attributed to the competition on Langmuir sorption sites between CO₂ and the other existing gases in the mixture (N₂, and CH₄).

As a result of the decrease in the mixed-gas CO₂ permeability coefficients with slight changes on mixed-gas CH₄ permeability coefficients, the CO₂/CH₄ selectivity coefficients decreased when the pressure increased from 300 to 900 psi for all copolyimides (FIGS. 6A-6C). The mixed-gas CO₂/CH₄ selectivity showed a clear dependence on the overall molar ratio of comonomers. For instance, the higher the molar ratio of PABZ within the polymer's backbone, the higher the mixed-gas CO₂/CH₄ selectivity coefficients.

The permeability and selectivity results at elevated feed pressures and for a multicomponent gas mixture make of the durene:PABZ series of copolyimides very attractive potential materials for industrial natural gas sweetening applications.

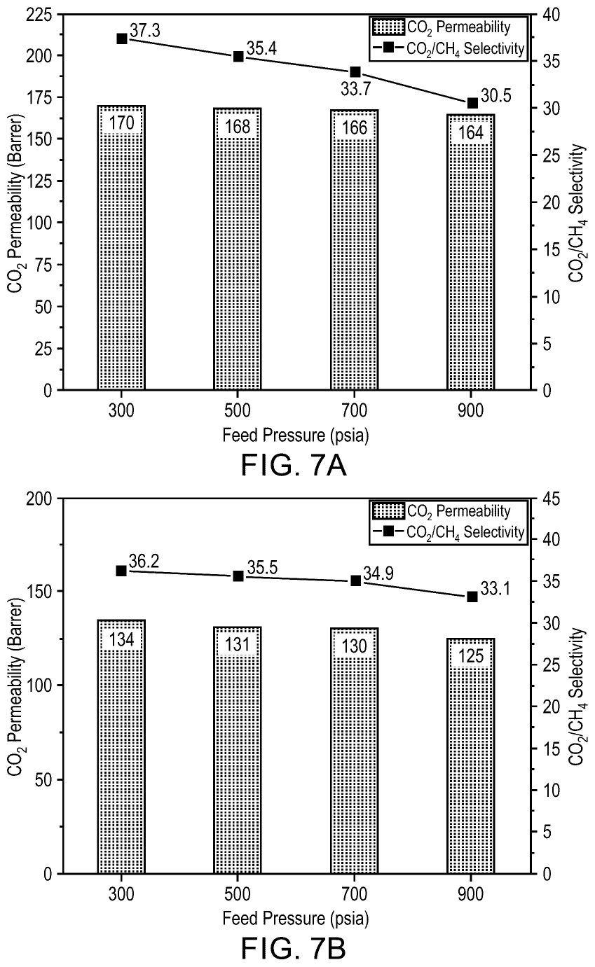

Moreover, membranes prepared from 6FDA-DAM/PABZ (3:1) and 6FDA-DAM/PABZ (2:1) were studied in a similar fashion to that of the durene/PABZ series using the same gas mixture composition and same testing conditions of pressure and temperature. The obtained data are listed in Table 6 and shown in FIGS. 7A-7B.

TABLE 6
Sweet mixed-gas permeability and selectivity coefficients of the
DAM:PABZ series of copolymers at various feed pressures and 22° C.

| | | Permeability coefficients | | | Selectivity | |
|---|---|---|---|---|---|---|
| | P | (Barrer) | | | coefficients | |
| Polymer | (psi) | N₂ | CH₄ | CO₂ | N₂/CH₄ | CO₂/CH₄ |
| 6FDA-DAM/PABZ (3:1) | 300 | 3.54 | 4.54 | 170 | 0.779 | 37.3 |
| | 500 | 3.73 | 4.73 | 168 | 0.788 | 35.4 |
| | 700 | 3.80 | 4.93 | 166 | 0.771 | 33.7 |
| | 900 | 4.06 | 5.37 | 164 | 0.755 | 30.5 |
| 6FDA-DAM/PABZ (2:1) | 300 | 2.93 | 3.71 | 134 | 0.789 | 36.2 |
| | 500 | 2.83 | 3.68 | 131 | 0.769 | 35.5 |
| | 700 | 2.94 | 3.72 | 130 | 0.790 | 34.9 |
| | 900 | 2.90 | 3.77 | 125 | 0.771 | 33.1 |

As can be seen in FIG. 7A, the mixed-gas CO₂ permeability coefficient of the 6FDA-DAM/PABZ (3:1) copolyimide membrane slightly decreased by ˜3% with an increase in feed pressure from 300 psi to 900 psi. This slight change in the CO₂ permeability coefficients indicates the stability of the membrane matrix to elevated gas feed pressures.

The corresponding CO₂/CH₄ selectivity coefficients of 6FDA-DAM/PABZ (3:1) illustrated in FIG. 7A at various feed pressures depicted a decrease of ˜18% in values with an increase in the feed pressure from 300 psi to 900 psi. This change is attributed to the prominent change in CO₂ permeability coefficients with slight change in the CH₄ permeability.

The sweet mixed-gas separation performances at 900 psi of 6FDA-durene/PABZ (3:1) and 6FDA-DAM/PABZ (3:1) copolyimide membranes were used to study the effect of comonomer type on the PABZ-containing copolyimide. For instance, the 6FDA-durene/PABZ (3:1) copolyimide membrane possessed a higher mixed-gas CO₂ permeability (206 Barrer) than that of 6FDA-DAM/PABZ (3:1) (164 Barrer). However, due to the permeability-selectivity trade-off relationship, the mixed-gas CO₂/CH₄ selectivity of 6FDA-DAM/PABZ (3:1) is ˜22% higher than that of 6FDA-durene/PABZ (3:1). Finally, it is important to note that all of the polymeric membranes described in Examples 1-6 were resistant to plasticization or swelling at elevated feed pressures, such as 900 psi.

### Example 12—Temperature Study

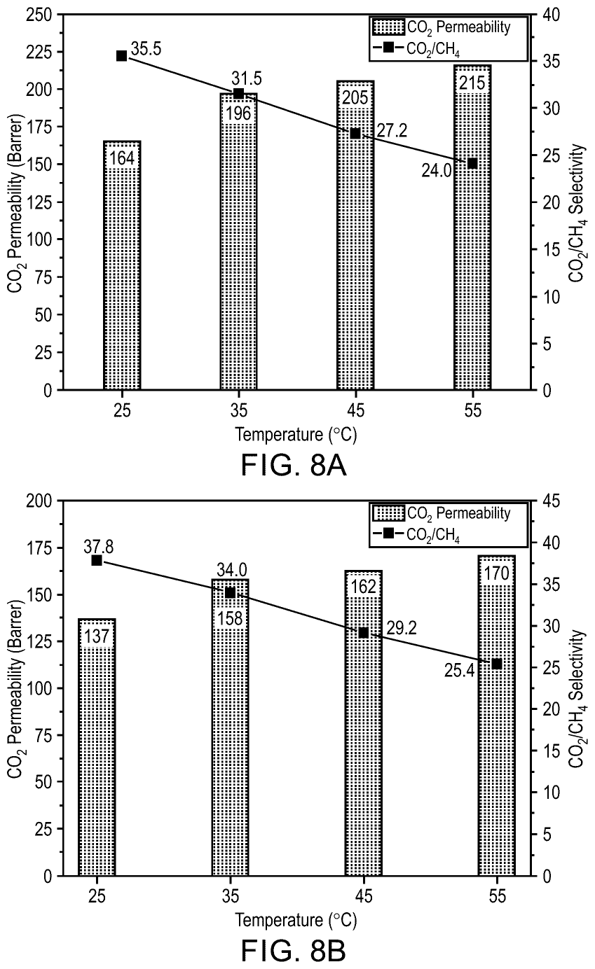

Based on the attractive experimental results obtained from the gas feed pressure change on mixed-gas separation properties, performance of the polymeric membranes was evaluated using the same mixture (28 mol. % CO₂, 62 mol. % CH₄, and 10 mol. % N₂) at various operating temperatures (25° C., 35° C., 45° C., and 55° C.) at a constant gas feed pressure of 500 psi. Examples of the obtained results for the DAM:PABZ series of copolyimide membranes are illustrated in FIGS. 8A-8B.

As can be seen from the results depicted in FIGS. 8A-8B, the mixed-gas CO₂ permeability coefficient tended to increase with increasing operational temperature. This change can be attributed to the increase in kinetic energy of gaseous molecules in the mixture and the change in the dynamic free volume of polymeric chains within the membrane matrix. As a result, the mixed-gas CO₂/CH₄ selectivity coefficients tended to decrease with increasing temperature, which is in line with the known “trade-off” relationship between permeability and selectivity. The change in the selectivity coefficient was due to the increase in dynamic free volume of the membrane matrix, which allowed the slow diffusing molecules, such as methane, to diffuse faster, and hence, their corresponding permeability increased.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

Exemplary embodiments include:

1. A polymer comprising:
a structural repeat unit of Formula (I):

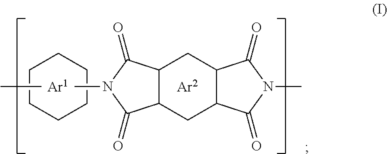

and
a structural repeat unit of Formula (II):

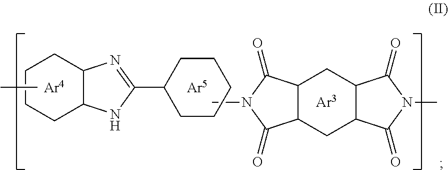

wherein:
Ar¹ is selected from:

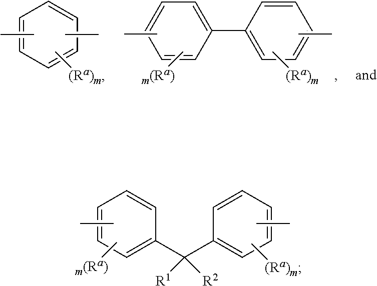

Ar² is selected from:

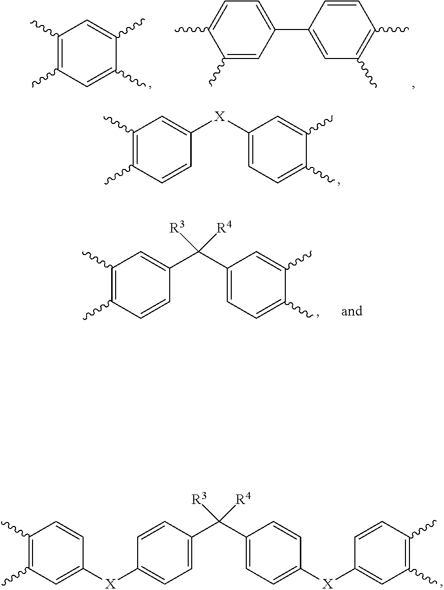

where [symbol] indicates the point of attachment to the

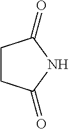

groups in Formula (I);
Ar³ is selected from:

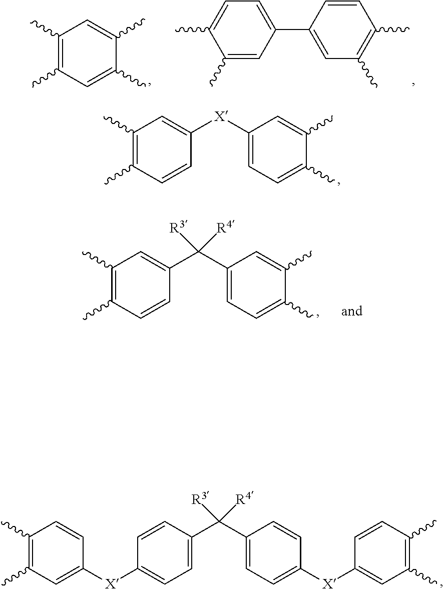

where [symbol] indicates the point of attachment to the

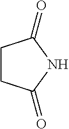

groups in Formula (II);
group

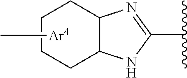

is selected from:

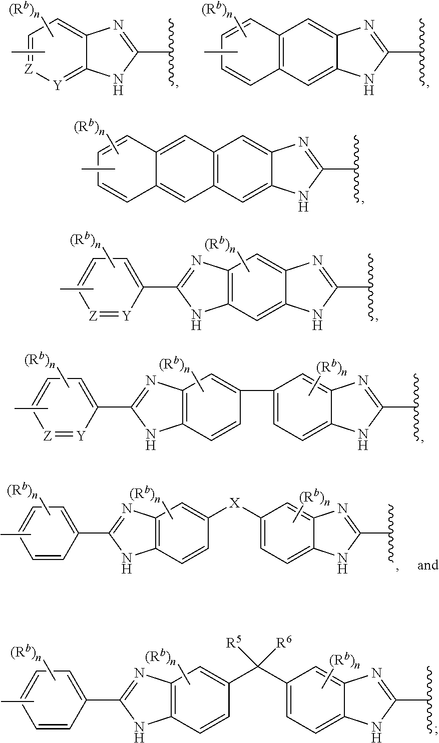

Ar⁵ is absent or is selected from:

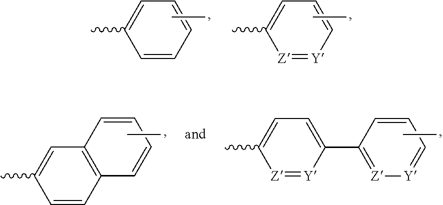

where [symbol] indicates the point of attachment to the

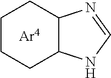

group in Formula (II);
X is NH, O, or S;
X′ is NH, O, or S;
Y is N or CH;
Y′ is N or CH;
Z is N or CH;
Z′ is N or CH;
R¹ and R² are each independently selected from H, C₁₋₆ alkyl, and C₁₋₆ haloalkyl; or, R¹ and R², together with the C atom to which they are attached, form a 6-14 membered aromatic group or a 6-14 membered heteroaromatic group, wherein the 6-14 membered aromatic group or the 6-14 membered heteroaromatic group are optionally substituted with 1, 2, 3, or 4 independently selected R^{1A} substituents;
R³, R^{3′}, R⁴, and R^{4′} are each independently selected from H, C₁₋₆ alkyl, and C₁₋₆ haloalkyl;
or, R³ and R⁴ or R^{3′} and R^{4′}, together with the C atom to which they are attached, form a carbonyl (═O) group;
R⁵ and R⁶ are each independently selected from H, C₁₋₆ alkyl, and C₁₋₆ haloalkyl;
or, R⁵ and R⁶, together with the C atom to which they are attached, form a carbonyl (═O) group;
each R^{a} is independently selected from halo, OH, C₁₋₆ alkyl, and C₁₋₆ haloalkyl;
each R^{b} is independently selected from halo, OH, C₁₋₆ alkyl, and C₁₋₆ haloalkyl;
each R^{1A} is independently selected from halo, OH, C₁₋₆ alkyl, and C₁₋₆ haloalkyl;
m is an integer between 0 and 8; and
n is an integer between 0 and 10;
wherein the polymer comprises the structural repeat unit of Formula (I) and the structural repeat unit of Formula (II) in a molar ratio of about 1:1 to about 3:1.

2. The polymer of embodiment 1, wherein each R^{a} is independently selected from halo, OH, C₁₋₄ alkyl, and CF₃.

3. The polymer of embodiment 1 or 2, wherein Ar¹ is

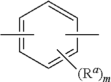

and m is an integer between 1 and 4.

4. The polymer of any one of embodiments 1-3, wherein each R^{a} is independently C₁₋₄ alkyl.

5. The polymer of any one of embodiments 1-4, wherein each R^{a} is methyl.

6. The polymer of embodiment 1, wherein Ar¹ is selected from:

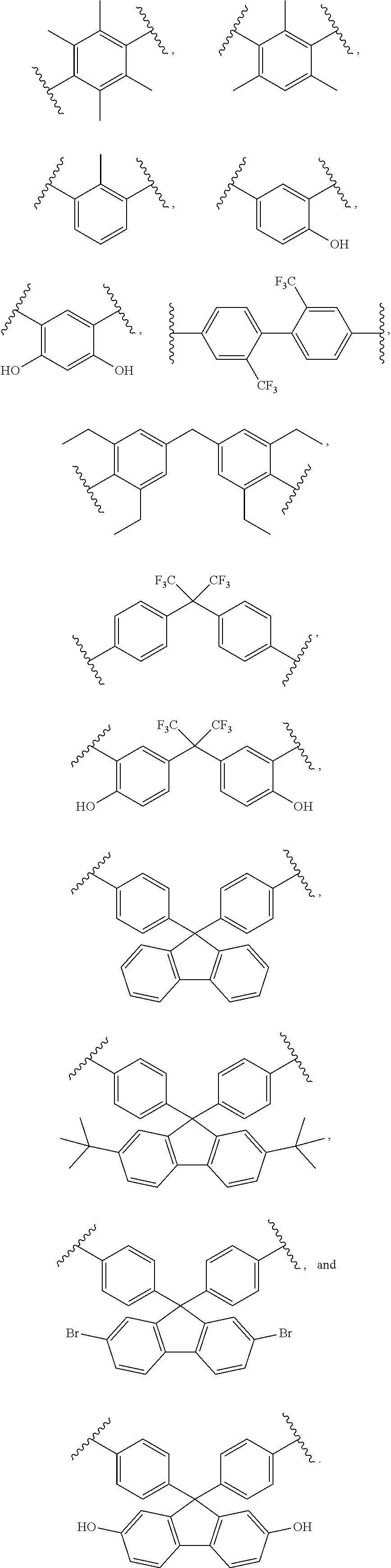

7. The polymer of embodiment 1 or 6, wherein Ar¹ is

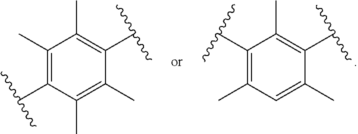

8. The polymer of any one of embodiments 1, 6, and 7, wherein X is O.

9. The polymer of any one of embodiments 1-8, wherein R³ and R⁴ are each independently methyl or CF₃, or, R³ and R⁴, together with the C atom to which they are attached, form a carbonyl (═O) group.

10. The polymer of any one of embodiments 1-9, wherein Ar² is selected from:

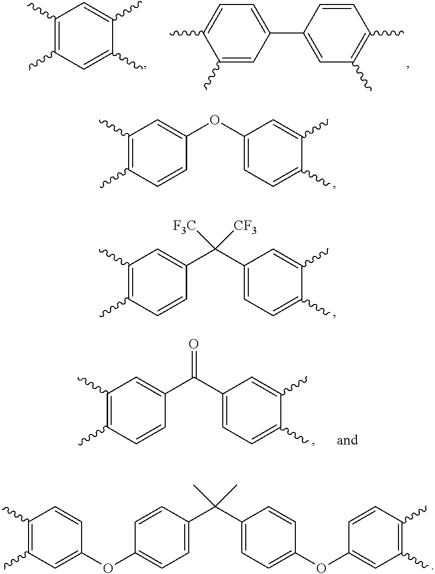

11. The polymer of any one of embodiments, 1-10, wherein Ar² is

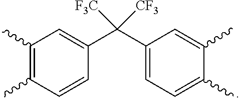

12. The polymer of any one of embodiments 1-11, wherein X′ is O.

13. The polymer of any one of embodiments 1-12, wherein R^{3′} and R^{4′} are each independently methyl or CF₃, or, R^{3′} and R^{4′}, together with the C atom to which they are attached, form a carbonyl (═O) group.

14. The polymer of any one of embodiments 1-13, wherein Ar³ is selected from:

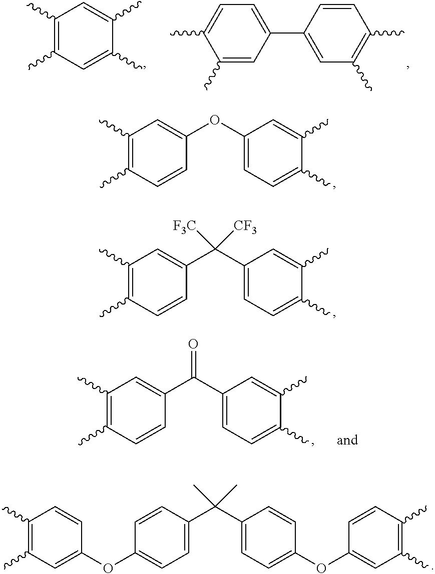

15. The polymer of any one of embodiments 1-14, wherein Ar³ is

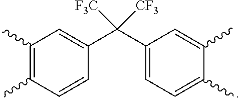

16. The polymer of any one of embodiments 1-15, wherein the group

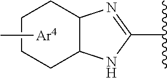

is selected from:

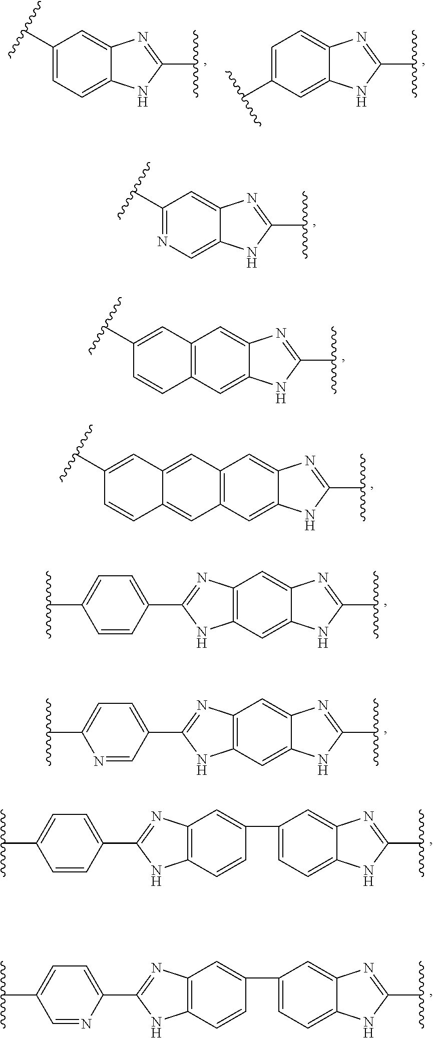

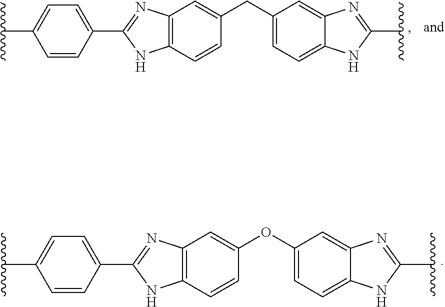 [SMILES: *c1ccc(-c2nc3cc(Cc4ccc5[nH]c(*)nc5c4)ccc3[nH]2)cc1 ; *c1ccc(-c2nc3cc(Oc4ccc5[nH]c(*)nc5c4)ccc3[nH]2)cc1]

17. The polymer of any one of embodiments 1-16, wherein Ar⁵ is selected from:

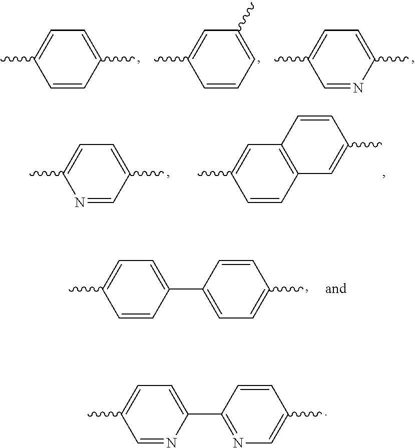

18. The polymer of any one of embodiments 1-17, wherein the group

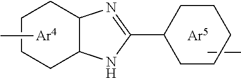

is selected from:

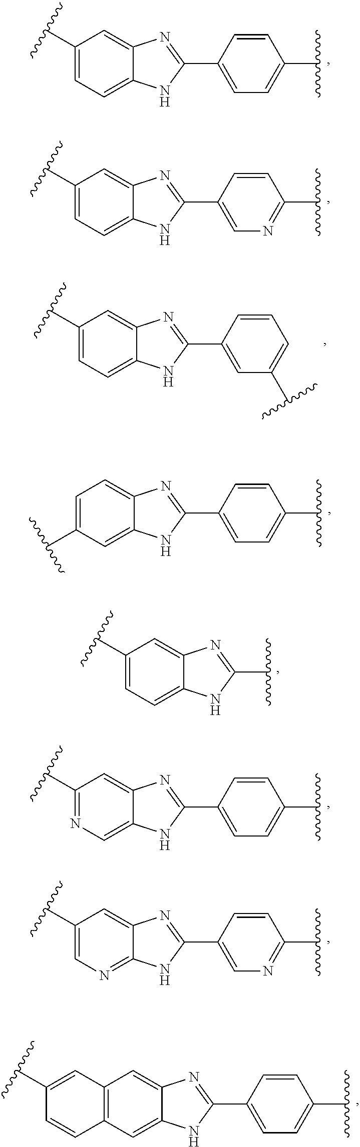

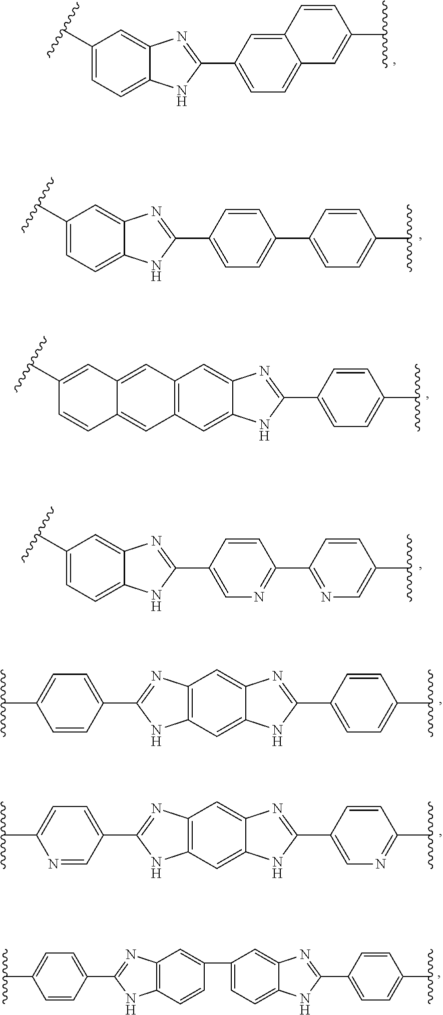

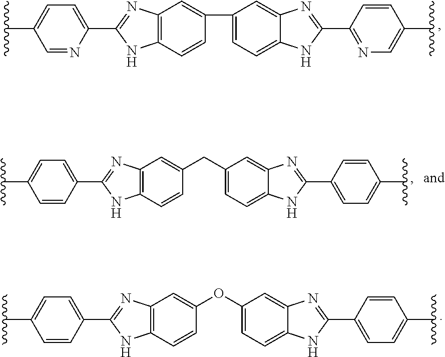 [SMILES: *c1ccc(-c2nc3cc(-c4ccc5[nH]c(-c6ccc(*)cn6)nc5c4)ccc3[nH]2)nc1 ; *c1ccc(-c2nc3cc(Cc4ccc5[nH]c(-c6ccc(*)cc6)nc5c4)ccc3[nH]2)cc1 ; *c1ccc(-c2nc3cc(Oc4ccc5[nH]c(-c6ccc(*)cc6)nc5c4)ccc3[nH]2)cc1]

19. The polymer of any one of embodiments 1-18, wherein the structural repeat unit of Formula (I) is selected from:

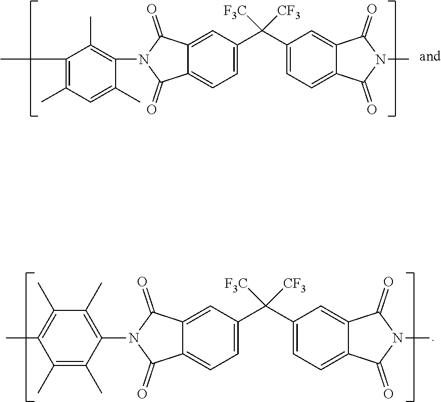

20. The polymer of any one of embodiments 1-19, wherein the structural repeat unit of Formula (II) is:

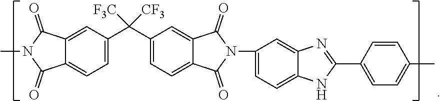

21. The polymer of embodiment 1, having the structure:

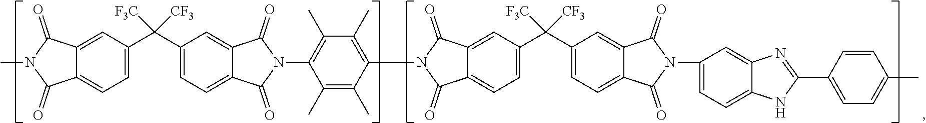

wherein the structural repeat unit of Formula (I) and the structural repeat unit of Formula (II) are present in a molar ratio of about 1:1, about 2:3, or about 3:1.

22. The polymer of embodiment 1, having the structure:

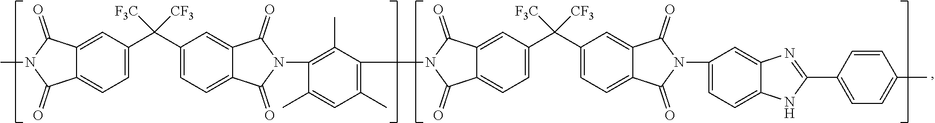

wherein the structural repeat unit of Formula (I) and the structural repeat unit of Formula (II) are present in a molar ratio of about 2:1 or about 3:1.

23. The polymer of any one of embodiments 1-22, having a number-average molecular weight of about 1,000 g/mol to about 1,000,000 g/mol.

24. A membrane comprising the polymer of any one of embodiments 1-23.

25. The membrane of embodiment 24, comprising about 99 wt % or less of the polymer.

26. A method for separating CO₂ and H₂S from natural gas, the method comprising:
introducing a natural gas stream to the membrane of embodiment 24 or 25; and
separating the CO₂ and the H₂S from the natural gas stream.

27. The method of embodiment 26, wherein the natural gas stream comprises about 1 vol % to about 30 vol % of CO₂ and about 1 vol % to about 40 wt % of H₂S, prior to separating the CO₂ and the H₂S from the natural gas stream.

What is claimed is:

1. A polymer comprising:
a structural repeat unit of Formula (I): 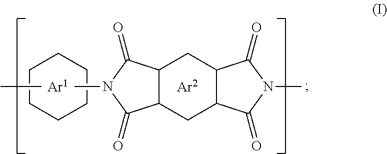
and
a structural repeat unit of Formula (II): 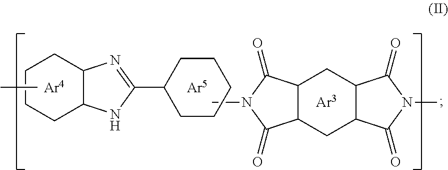
wherein:
Ar¹ is selected from: 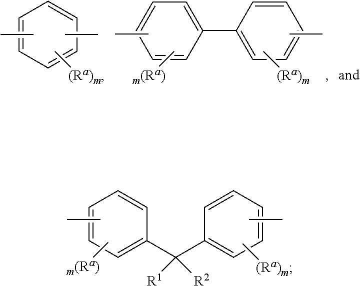
Ar² is selected from: 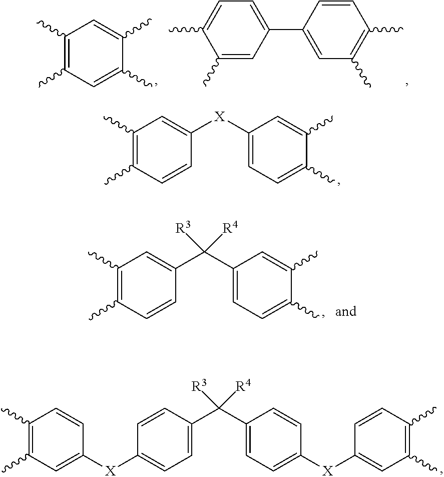
where [symbol] indicates the point of attachment to the 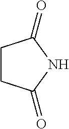
groups in Formula (I);
Ar³ is selected from: 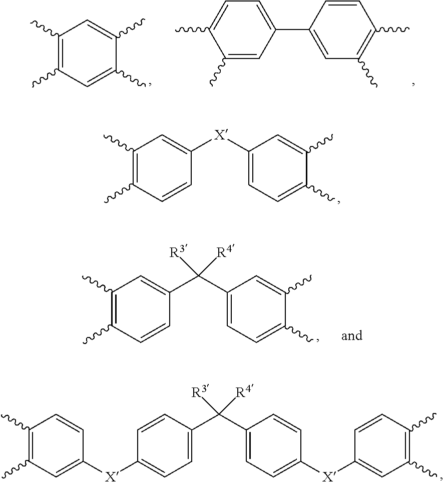
where [symbol] indicates the point of attachment to the 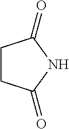
groups in Formula (II);
group 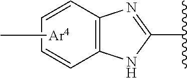
is selected from: 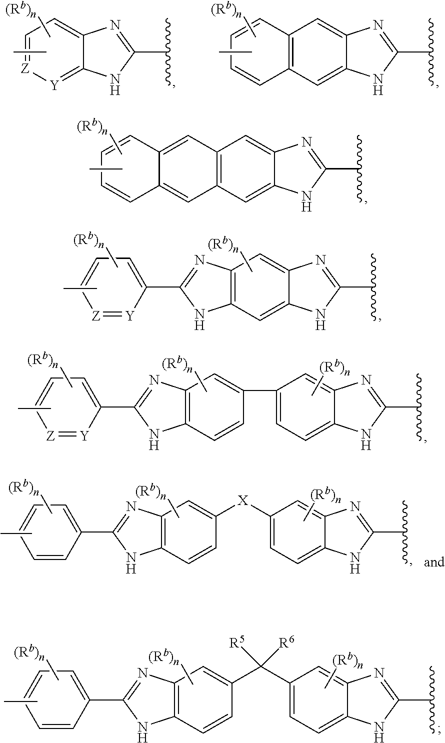
Ar⁵ is absent or is selected from: 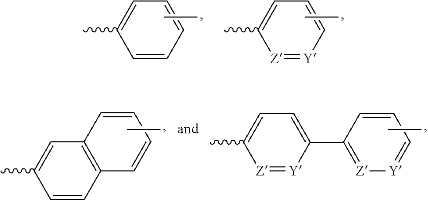
where [symbol] indicates the point of attachment to the 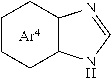
group in Formula (II);
X is NH, O, or S;
X′ is NH, O, or S;
Y is N or CH;
Y′ is N or CH;
Z is N or CH;
Z′ is N or CH;
R¹ and R² are each independently selected from H, C₁₋₆ alkyl, and C₁₋₆ haloalkyl;
or, R¹ and R², together with the C atom to which they are attached, form a 6-14 membered aromatic group or a 6-14 membered heteroaromatic group, wherein the 6-14 membered aromatic group or the 6-14 membered heteroaromatic group are optionally substituted with 1, 2, 3, or 4 independently selected R^{1A} substituents;
R³, R^{3′}, R⁴, and R^{4′} are each independently selected from H, C₁₋₆ alkyl, and C₁₋₆ haloalkyl;
or, R³ and R⁴ or R^{3′} and R^{4′}, together with the C atom to which they are attached, form a carbonyl (═O) group;
R^{S} and R⁶ are each independently selected from H, C₁₋₆ alkyl, and C₁₋₆ haloalkyl;
or, R⁵ and R⁶, together with the C atom to which they are attached, form a carbonyl (═O) group;
each R^{a} is independently selected from halo, OH, C₁₋₆ alkyl, and C₁₋₆ haloalkyl;
each R^{b} is independently selected from halo, OH, C₁₋₆ alkyl, and C₁₋₆ haloalkyl;
each R^{1A} is independently selected from halo, OH, C₁₋₆ alkyl, and C₁₋₆ haloalkyl;
m is an integer between 0 and 8; and
n is an integer between 0 and 10;
wherein the polymer comprises the structural repeat unit of Formula (I) and the structural repeat unit of Formula (II) in a molar ratio of about 1:1 to about 3:1.

2. The polymer of claim 1, wherein each R^{a} is independently selected from halo, OH, C₁₋₄ alkyl, and CF₃.

3. The polymer of claim 2, wherein Ar¹ is 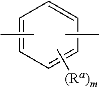
and m is an integer between 1 and 4.

4. The polymer of claim 3, wherein each R^{a} is independently C₁₋₄ alkyl.

5. The polymer of claim 4, wherein each R^{a} is methyl.

6. The polymer of claim 1, wherein Ar¹ is selected from:

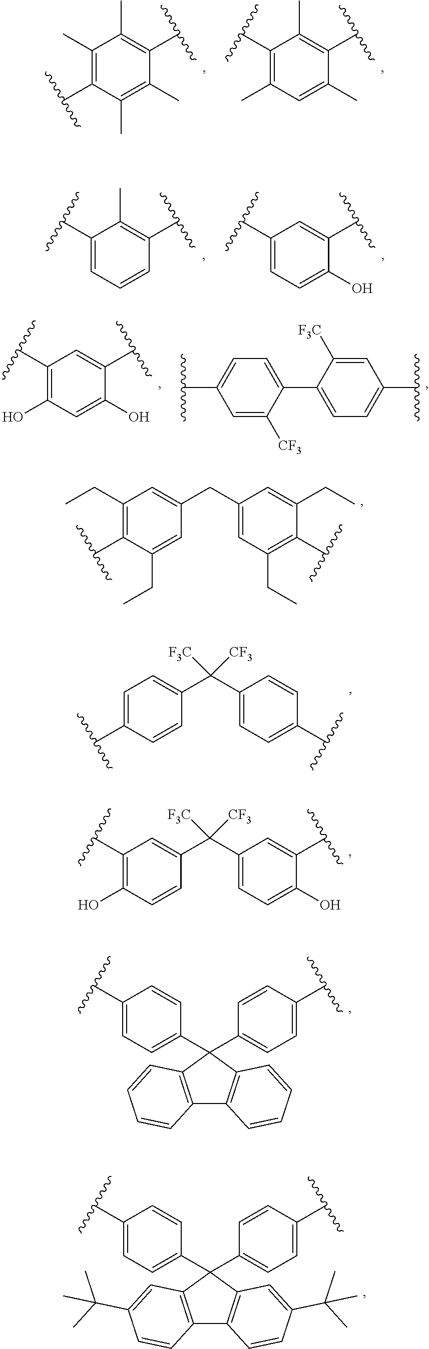

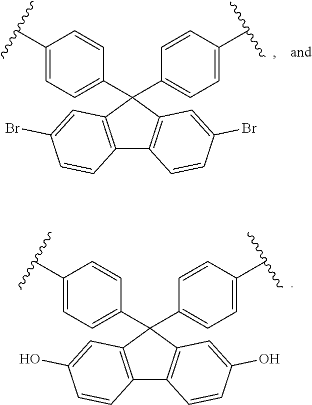 [SMILES: *c1ccc(C2(c3ccc(*)cc3)c3cc(Br)ccc3-c3ccc(Br)cc32)cc1 ; *c1ccc(C2(c3ccc(*)cc3)c3cc(O)ccc3-c3ccc(O)cc32)cc1]

7. The polymer of claim 1, wherein Ar¹ is

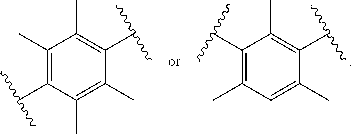

8. The polymer of claim 1, wherein X is O.

9. The polymer of claim 1, wherein R³ and R⁴ are each independently methyl or CF₃, or, R³ and R⁴, together with the C atom to which they are attached, form a carbonyl (═O) group.

10. The polymer of claim 1, wherein Ar² is selected from:

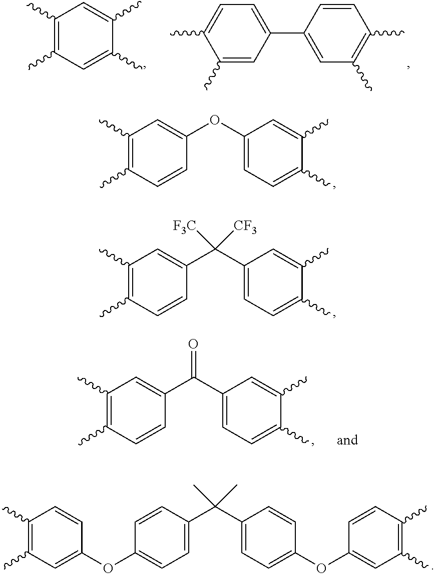

11. The polymer of claim 1, wherein Ar² is

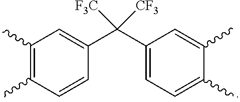

12. The polymer of claim 1, wherein X′ is O.

13. The polymer of claim 1, wherein R^{3′} and R^{4′} are each independently methyl or CF₃, or, R^{3′} and R^{4′}, together with the C atom to which they are attached, form a carbonyl (═O) group.

14. The polymer of claim 1, wherein Ar³ is selected from:

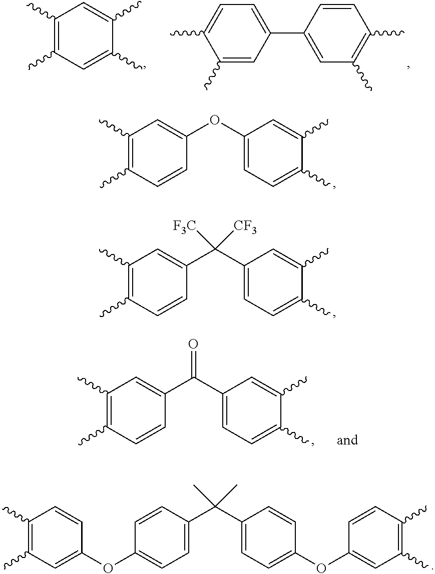

15. The polymer of claim 1, wherein Ar³ is

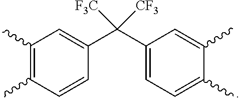

16. The polymer of claim 1, wherein the group 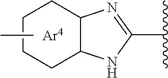
is selected from:

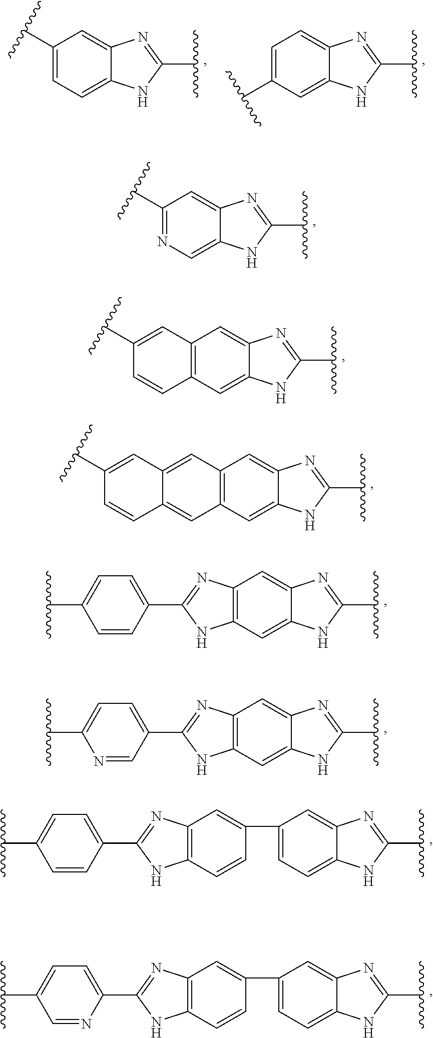

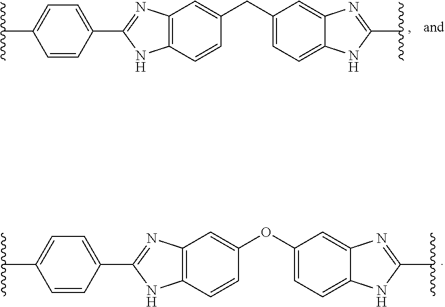 [SMILES: *c1ccc(-c2nc3cc(Cc4ccc5[nH]c(*)nc5c4)ccc3[nH]2)cc1 ; *c1ccc(-c2nc3cc(Oc4ccc5[nH]c(*)nc5c4)ccc3[nH]2)cc1]

17. The polymer of claim 1, wherein Ar⁵ is selected from:

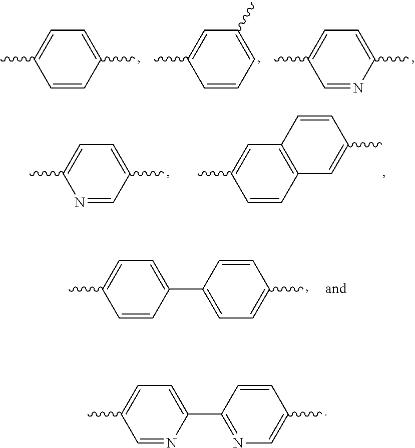

18. The polymer of claim 1, wherein the group 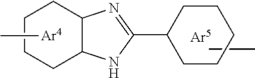
is selected from:

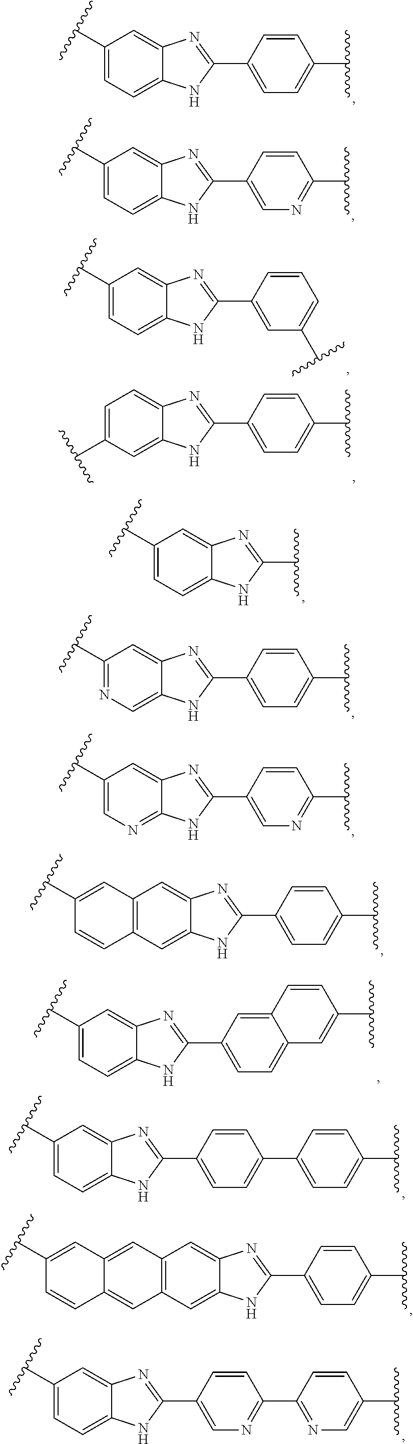

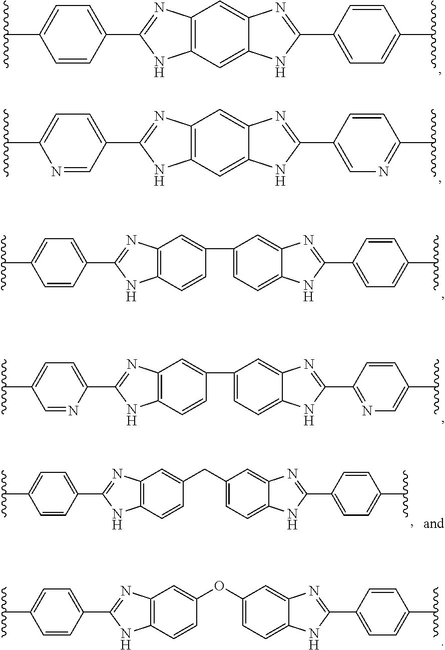 [SMILES: *c1ccc(-c2nc3cc4nc(-c5ccc(*)cc5)[nH]c4cc3[nH]2)cc1 ; *c1ccc(-c2nc3cc4nc(-c5ccc(*)nc5)[nH]c4cc3[nH]2)cn1 ; *c1ccc(-c2nc3cc(-c4ccc5[nH]c(-c6ccc(*)cc6)nc5c4)ccc3[nH]2)cc1 ; *c1ccc(-c2nc3cc(-c4ccc5[nH]c(-c6ccc(*)cn6)nc5c4)ccc3[nH]2)nc1 ; *c1ccc(-c2nc3cc(Cc4ccc5[nH]c(-c6ccc(*)cc6)nc5c4)ccc3[nH]2)cc1 ; *c1ccc(-c2nc3cc(Oc4ccc5[nH]c(-c6ccc(*)cc6)nc5c4)ccc3[nH]2)cc1]

19. The polymer of claim 1, wherein the structural repeat unit of Formula (I) is selected from:

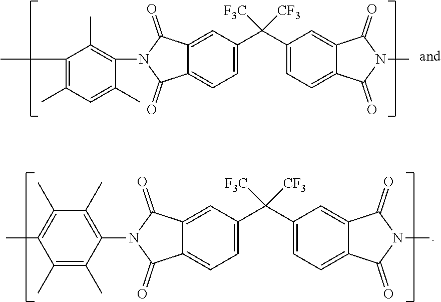

20. The polymer of claim 1, wherein the structural repeat unit of Formula (II) is:

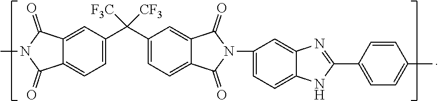

21. The polymer of claim 1, having the structure: 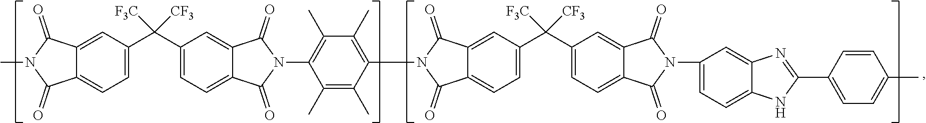
wherein the structural repeat unit of Formula (I) and the structural repeat unit of Formula (II) are present in a molar ratio of about 1:1, about 2:3, or about 3:1.

22. The polymer of claim 1, having the structure: 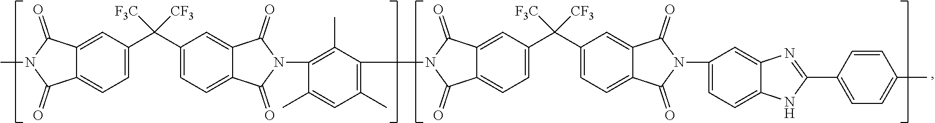
wherein the structural repeat unit of Formula (I) and the structural repeat unit of Formula (II) are present in a molar ratio of about 2:1 or about 3:1.

23. The polymer of claim 1, having a number-average molecular weight of about 1,000 g/mol to about 1,000,000 g/mol.

24. A membrane comprising the polymer of claim 1.

25. The membrane of claim 24, comprising about 99 wt % or less of the polymer.

26. A method for separating CO₂ and H₂S from natural gas, the method comprising:
introducing a natural gas stream to the membrane of claim 24; and
separating the CO₂ and the H₂S from the natural gas stream.

27. The method of claim 26, wherein the natural gas stream comprises about 1 vol % to about vol % of CO₂ and about 1 vol % to about 40 wt % of H₂S, prior to separating the CO₂ and the H₂S from the natural gas stream.
